(19) United States
(12) Patent Application Publication
(10) Pub. No.: US 2015/0088922 A1
(43) Pub. Date: Mar. 26, 2015

(54) SYSTEM AND METHOD FOR MANAGING OBJECT

(71) Applicant: SK PLANET CO., LTD., Seoul (KR)

(72) Inventor: Jaehyung Huh, Seongnam-si (KR)

(21) Appl. No.: 14/008,957

(22) PCT Filed: Oct. 31, 2012
(86) PCT No.: PCT/KR2012/009012

§ 371 Date: Sep. 30, 2013

(30) Foreign Application Priority Data
Feb. 1, 2012 (KR) 10-2012-0010524
Feb. 2, 2012 (KR) 10-2012-0010799
Feb. 2, 2012 (KR) 10-2012-0010857
Feb. 2, 2012 (KR) 10-2012-0010878

(51) Int. Cl. G06F 17/30

(52) U.S. Cl. CPC G06F 17/30864; G06F 17/30312
USPC 707/769; 707/812

(57) ABSTRACT

Disclosed are a system and a method for managing an object. The system includes a service apparatus configured to acquire content information selected for each application service, transmit the acquired content information to make a request for registering the content information as an object, and load and execute the registered object; and an object management apparatus configured to define a basic object structure for registering the object, set one or more expanded object structures based on the defined basic object structure according to a type of designated content information, select, when content information is received from the service apparatus, an expanded object structure corresponding to a type of the received content information among the one or more set expanded object structures, extract attribute data constituting the received content information, insert the extracted attribute data to a parameter designated to the selected expanded object structure, and register the object.

### FIELD

The present disclosure relates to a method of registering and sharing a personal object, and more particularly to, a system and a method for defining a basic object structure for registering content information designated by a user as an object with respect to each of various application services and applying an expanded object structure based on the basic object structure according to a type of received content information, so as to register and manage content information for each type as an object.

Further, the present disclosure relates to a system and a method for registering a component of an application service as a sharable object according to user's designation with respect to each of various application services provided on the Web, searching for the registered object, and loading the found object between the application services, so as to mutually use the object.

Moreover, the present disclosure relates to a system and a method for registering and managing content information designated by a user as an object with respect of each of various application services, inquiring about the content information registered as the object, and providing a reuse service to users accessing through various service apparatuses.

Furthermore, the present disclosure relates to a system and a method for registering content information according to user's designation as an object to configure a service page for each user and providing a sharing service of the registered object to users accessing the corresponding service page when various application services are used.

### BACKGROUND

In general, an object refers to an image configuring an application, a content including a multimedia, and a function of supporting an application service, which configures a corresponding application service.

In connection with this, an object included in a conventional application service only has an access or use authority on the corresponding application service, but cannot perform an access through a different route or additionally use a new function.

In other words, as the conventional object cannot support mutual sharing function between application services, various demands of users of the application services are not satisfied. Further, the conventional object has a large limitation in creating a new application service in a Web environment and applying the new application.

### SUMMARY

An aspect of the present disclosure is to define a basic object structure for registering content information designated by a user as an object with respect to each of various application services and apply an expanded object structure based on the basic object structure according to a type of received content information, so as to register and manage content information for each type as an object.

Further, another aspect of the present disclosure is to register a component of an application service as a sharable object according to user's designation with respect to each of various application services provided on the Web, search for the registered object, and load the found object between the application services, so as to mutually use the object.

Moreover, another aspect of the present disclosure is to register and manage content information designated by a user as an object with respect to each of various application services, inquire about the content information registered as the object, and provide a reuse service to users accessing through various service apparatuses.

Furthermore, another aspect of the present disclosure is to register content information according to user's designation as an object to configure a service page for each user and provide a sharing service of the registered object to users accessing the corresponding service page when various application services are used.

In accordance with an embodiment of the present disclosure, an object management system is provided. The object management system includes a service apparatus configured to acquire content information selected for each application service, transmit the acquired content information to make a request for registering the content information as an object, and load and execute the registered object; and an object management apparatus configured to define a basic object structure for registering the object, set one or more expanded object structures based on the defined basic object structure according to a type of designated content information, select, when content information is received from the service apparatus, an expanded object structure corresponding to a type of the received content information among the one or more set expanded object structures, extract attribute data constituting the received content information, insert the extracted attribute data to a parameter designated to the selected expanded object structure, and register the object.

In accordance with another embodiment of the present disclosure, an object management apparatus is provided. The object management apparatus includes a structure configuration unit configured to define a basic object structure for registering an object of content information selected for each application service and set one or more expanded object structures based on the defined basic object structure according to a type of designated content information; an information receiver configured to acquire the content information selected for each application service; and an object registering unit configured to select an expanded object structure corresponding to a type of the received content information among the set one or more expanded object structures, extract attribute data constituting the received content information, and insert the extracted attribute data into a configuration parameter designated to the selected expanded object structure, so as to perform an object registration.

Preferably, the object management apparatus further includes a load processor configured to extract and provide an object registered for each type of content information according to a load of the registered object.

Preferably, the structure setting unit may calculate a basic data stricture for combining different data structures according to a type of designated content information, designate two or more configuration parameters corresponding to the calculated basic data structure, and combine the designated two or more configuration parameters, so as to define the basic object structure.

Preferably, the structure setting unit sets each of the expanded object structures corresponding to the type of the content information by changing and designating the two or more configuration parameters included in the basic object structure.

In accordance with another embodiment of the present disclosure, an object management method is provided. The object management method includes defining a basic object structure for registering an object of content information selected for each application service by an object management apparatus; setting one or more expanded object structures based on the defined basic object structure according to a type of designated content information by the object management apparatus; transmitting the content information selected for each application service and making a request for registering the content information as an object by a service apparatus; selecting an expanded object structure corresponding to a type of the content information selected from the service apparatus by the object management apparatus; selecting an expanded object structure corresponding to the type of the received content information; and extracting attribute data constituting the received content information, inserting the extracted attribute data into a configuration parameter designated to the selected expanded object structure, so as to perform an object registration.

In accordance with another embodiment of the preset disclosure, a method of operating an object management apparatus is provided. The method includes defining a basic object structure for registering an object of content information selected for each application service; setting one or more expanded object structures based on the defined basic object structure according to a type of designated content information; acquiring the content information selected for each application service; selecting an expanded object structure corresponding to a type of the acquired content information among the set one or more expanded object structures; and extracting attribute data constituting the received content information, inserting the extracted attribute data into a configuration parameter designated to the selected expanded object structure, so as to perform an object registration.

Preferably, the method further includes extracting and providing an object registered for each type of content information according to a load of the registered object.

Preferably, the defining of the basic object structure includes calculating a basic data structure for combining different data structures according to a type of designated content information; designating two or more configuration parameters corresponding to the calculated basic data structure; and defining the basic object structure by combining the designated two or more configuration parameters.

Preferably, the setting of the one or more expanded object structures includes setting each of the expanded object structures corresponding to a type of the content information by changing and designating the two or more configuration parameters included in the basic object structure.

In accordance with another embodiment of the present disclosure, an object sharing system is provided. The object sharing system includes a service apparatus configured to provide one or more application services to accessed users, transmit service information according to a user's designation to make a request for registering the service information as an object in accordance with each of the application services, receive a search list of the registered object based on an object sharing request by a user according to provision of a particular application service, and load and execute registered objects corresponding to remaining application services except for the particular application service among the one or more application services based on the search list; and an object management apparatus configured to register the service information received from the service apparatus as an object, provide a search list of registered objects according to an object sharing request by the service apparatus, and extract and provide the loaded object based on the search list.

In accordance with another embodiment of the present disclosure, a service apparatus is provided. The service apparatus includes a service provider configured to provide one or more application services to accessed users; an object registering unit configured to extract service information according to a user's designation in accordance with each of the application services and register the extracted service information as an object; and an object executer configured to load and execute registered objects corresponding to remaining application services except for a particular application service among the one or more application services based on an object sharing request by a user according to provision of the particular application service.

Preferably, when the object of the service information is registered, the object registering unit transmits and additionally registers type information for identifying a type of the transmitted service information.

Preferably, when the object of the service information is registered, the object registering unit additionally registers service identification information for identifying an execution environment of the corresponding application service from which the service information is extracted.

Preferably, when the object of the service information is registered, the object registering unit additionally registers sharing setting information for designating counterparts with which each object is shared.

Preferably, when the request by the user according to the provision of the particular application service is received, the object executer acquires a search list of the registered object and loads and executes one or more registered objects corresponding to the remaining application services except for the particular application service among the one or more application services based on the acquired search list.

In accordance with another embodiment of the present disclosure, an object management apparatus is provided. The object management apparatus includes a registration processor configured to receive service information designated to correspond to each of application services from a service apparatus providing one or more application services to accessed users and register the service information as an object; and a load processor configured to execute and provide registered objects corresponding to remaining application services except for a particular application service among the one or more application services when an object sharing request according to provision of the particular application service is received from the service apparatus.

Preferably, the registration processor additionally registers type information for distinguishing a type of the service information when the object of the service information received from the service apparatus is registered, and the load processor selects and provides an object requested to be shared based on type information of the registered object when the object sharing request according to the provision of the particular application service is received from the service apparatus.

Preferably, the registration processor additionally registers service identification information for identifying an execution environment of the corresponding application service from which the service information is extracted when the object of the service information received from the service apparatus is registered, and the load processor selects and provides an object executable in the particular application service based on the service identification information of the registered object when the object sharing request according to the provision of the particular application service is received from the service apparatus.

Preferably, when the object sharing request according to the provision of the particular application service is received from the service apparatus, the load processor identifies an execution environment of the registered object based on the service identification information, and converts a format of the corresponding object to a format executable in the particular application service and provides the converted format of the object when the identified execution environment is different from an execution environment of the particular application service.

Preferably, the registration processor receives sharing setting information corresponding to the service information received from the service apparatus and sets a counterpart with which each of the registered objects is shared when the object is registered, and the load processor identifies a counterpart transmitting the object sharing request, determines whether there is a counterpart with which the object is shared, and then provides the registered object when the object sharing request according to the provision of the particular application service is received from the service apparatus.

In accordance with another embodiment of the present disclosure, an object sharing method is provided. The object sharing method includes providing one or more application services to accessed users by a service apparatus; transmitting service information according to a user's designation to an object management apparatus in accordance with each of the application services; registering the service information received from the service apparatus as an object for each user; providing a search list of the registered object for each user according to an object sharing request by the service apparatus; and loading and executing registered objects corresponding to remaining application services except for the particular application service among the one or more application services based on the search list by the service apparatus.

In accordance with another embodiment of the present disclosure, a method of operating a service apparatus is provided. The method includes providing one or more application services to accessed users; extracting service information according to a user's designation in accordance with each of the application services and registering the extracted service information as an object; and loading and executing registered objects corresponding to remaining application services except for a particular application service among the one or more application services based on an object sharing request by a user according to provision of the particular application service.

Preferably, the extracting of the service information according to the user's designation in accordance with each of the application services and the registering of the extracted service information as the object includes, when the object of the service information is registered, transmitting type information for identifying a type of the transmitted service information.

Preferably, the extracting of the service information according to the user's designation in accordance with each of the application services and the registering of the extracted service information as the object includes, when the object of the service information is registered, additionally registering service identification information for identifying an execution environment of the corresponding application service from which the service information is extracted.

Preferably, the extracting of the service information according to the user's designation in accordance with each of the application services and the registering of the extracted service information as the object includes, when the object of the service information is registered, additionally registering sharing setting information for designating counterparts with which each object is shared.

Preferably, the loading and executing of the objects includes, when the request by the user according to the provision of the particular application service is received, acquiring a search list of the registered object; and loading and executing one or more registered objects corresponding to remaining application services except for the particular application service among the one or more application services based on the acquired search list.

In accordance with another embodiment of the present disclosure, a method of operating an object management apparatus is provided. The method includes receiving service information designated to correspond to each of application services from a service apparatus providing one or more application services to accessed users; registering the service information received from the service apparatus as an object for each user; and extracting and providing registered objects corresponding to remaining application services except for a particular application service among the one or more application services based on an object sharing request by the service apparatus according to provision of the particular application service.

Preferably, the registering of the service information received from the service apparatus as the object for each user includes additionally registering type information for distinguishing a type of the service information when the object of the service information received from the service apparatus is registered, and the extracting and providing of the registered objects includes selecting and providing an object requested to be shared based on type information of the registered object when the object sharing request according to the provision of the particular application service is received from the service apparatus.

Preferably, the registering of the service information received from the service apparatus as the object for each user includes additionally registering service identification information for identifying an execution environment of the corresponding application service from which the service information is extracted when the object of the service information received from the service apparatus is registered, and the extracting and providing of the registered objects includes selecting and providing an object executable in the particular application service based on the service identification information of the registered object when the object sharing request according to the provision of the particular application service is received from the service apparatus.

Preferably, the extracting and providing of the registered objects includes, when the object sharing request according to the provision of the particular application service is received from the service apparatus, identifying an execution environment of the registered object based on the service identification information and converting a format of the corresponding object to a format executable in the particular application service and provides the converted format of the object when the identified execution environment is different from an execution environment of the particular application service.

Preferably, the registering of the service information received from the service apparatus as the object for each user includes receiving sharing setting information corresponding to the service information received from the service apparatus and setting a counterpart with which each of the registered objects is shared when the object is registered, and the extracting and providing of the registered objects includes identifying a counterpart transmitting the object sharing request, determining whether there is a counterpart with which the object is shared, and then providing the registered object when the object sharing request according to the provision of the particular application service is received from the service apparatus.

In accordance with another embodiment of the present disclosure, a computer-readable recording medium is provided. The computer-readable recording medium includes receiving service information designated to correspond to each of application services from a service apparatus providing one or more application services to accessed users; registering the service information received from the service apparatus as an object for each user; and commands for executing the steps of extracting and providing registered objects corresponding to remaining application services except for a particular application service among the one or more application services based on an object sharing request by the service apparatus according to provision of the particular application service.

In accordance with another embodiment of the present disclosure, a personal object management system is provided. The personal object management system includes a service apparatus configured to acquire content information selected for each application service, transmit the acquired content information to make a request for registering the content information as an object, and load and execute the registered object; and an object management apparatus configured to distinguish the content information received from the service apparatus as an object for each application service, register the distinguished object, and extract and provide the corresponding object according to a load of the registered object.

In accordance with another embodiment of the present disclosure, a service apparatus is provided. The service apparatus includes a service access unit configured to access one or more application services; an information acquiring unit configured to acquire content information selected for each application service; an object registering unit configured to transmit the acquired content information and make a request for registering the content information as an object for each application service; and an object executer configured to load and execute a particular registered object while accessing a particular application service.

Preferably, the information acquiring unit provides each user interface according to accesses to one or more application services and acquires the content information selected for each application service through the user interface.

Preferably, the information acquiring unit provides a first user interface in accordance with an access to a first application service, acquires content information selected from at least one of the first application service and a second application service through the first user interface in a state where a second user interface is provided in accordance with an access to the second application service, and acquires content information selected from at least one of the second application service and the first application service through the second user interface.

Preferably, when the registered object is loaded, the object executer transmits pre-designated content format information, and acquires and executes the particular object of which a data format is converted based on the content format information.

In accordance with another embodiment of the present disclosure, an object management apparatus is provided. The object management apparatus includes an information receiver configured to receive acquired content information from a service apparatus acquiring the content information selected for each application service; a registration processor configured to distinguish the content information received from the service apparatus as an object for each application service and register the distinguished object; and a load processor configured to extract and provide the corresponding object according to a load of the registered object.

Preferably, the information receiver provides each user interface according to accesses to one or more application services and acquires the content information selected for each application service through the user interface.

Preferably, the information receiver provides a first user interface in accordance with an access to a first application service, receives the first user interface or content information acquired through the first user interface for at least one of the first application service and the second application service from the service apparatus providing the second user interface in accordance with the access to the second application service.

Preferably, the registration processor registers content information acquired through the first user interface for at least one of the first application service and the second application service as an object corresponding to the first application service and registers content information acquired through the second user interface for at least one of the first application service and the second application service as an object corresponding to the second application service.

Preferably, the load processor recognizes user identification information that accesses each of the application services according to a load of the registered object received from a particular service apparatus accessing one or more application services, identifies designated representative identification information corresponding to each of the recognized user identification information, and extracts and provides the registered object mapped into the identified representative identification information.

Preferably, the load processor identifies pre-designated content format information for each service apparatus according to a load of the registered object received from one or more service apparatuses, converts a data format of the extracted object based on the identified content format information, and provides the converted data format of the object.

In accordance with another embodiment of the present disclosure, a personal object management method is provided. The personal object management method includes acquiring content information selected for each application service by a service apparatus; transmitting the acquired content information and making a request for registering the content information as an object by the service apparatus; distinguishing the content information received from the service apparatus as an object for each application service and registering the distinguished object by an object management apparatus; loading the registered object while accessing a particular application service by the service apparatus; and extracting and providing the corresponding object according to a load of the object by the object management apparatus.

In accordance with another embodiment of the present disclosure, a method of operating a service apparatus is provided. The method includes accessing one or more application services; acquiring content information selected for each application service; transmitting the acquired content information and making a request for registering the content information as an object for each application service; and loading and executing a particular registered object while accessing a particular application service.

Preferably, the acquiring of the content information includes providing each of user interfaces according to accesses to one or more application services and acquiring the content information selected for each application service through the user interface.

Preferably, the acquiring of the content information includes providing a first user interface in accordance with an access to the first application service acquires content information selected from at least one of the first application service and a second application service through the first user interface in a state where a second user interface is provided in accordance with an access to the second application service, and acquires content information selected from at least one of the second application service and the first application service through the second user interface.

Preferably, the loading and executing of the particular registered object includes, when the registered object is loaded, transmitting pre-designated content format information, acquiring the particular object of which a data format is converted based on the content format information, and executing the object.

In accordance with another embodiment of the present disclosure, a method of operating an object management apparatus is provided. The method includes receiving acquired content information from a service apparatus acquiring the content information selected for each application service; distinguishing the content information received from the service apparatus as an object for each application service and registering the distinguished object; and extracting and providing the corresponding object according to a load of the registered object.

Preferably, the receiving of the content information includes providing each of user interfaces according to accesses to one or more application services and receiving acquired content information from the service apparatus acquiring the content information for each application service through the user interface.

Preferably, the receiving of the content information includes providing a first user interface in accordance with an access to a first application service, and receiving a first user interface or content information acquired through the first user interface for at least one of a first application service and a second application service from the service apparatus providing a second user interface in accordance with an access to the second application service.

Preferably, the distinguishing of the content information includes registering content information acquired through the first user interface for at least one of the first application service and the second application service as an object corresponding to the first application service and registering content information acquired through the second user interface for at least one of the first application service and the second application service as an object corresponding to the second application service.

Preferably, the extracting and providing of the corresponding object includes recognizing user identification information that accesses each of the application services according to a load of the registered object received from a particular service apparatus accessing one or more application services; identifying designated representative identification information corresponding to each of the recognized user identification information; and extracting and providing the registered object mapped into the identified representative identification information

Preferably, the extracting and providing of the corresponding object includes identifying pre-designated content format information for each service apparatus according to a load of the registered object received from one or more service apparatuses; converting a data format of the extracted object based on the identified content format information and providing the converted data format of the object.

In accordance with another embodiment of the present disclosure, a personal object sharing system is provided. The personal object sharing system includes a service apparatus configured to acquire content information selected for each application service, transmit the acquired content information to make a request for registering the content information as an object, and load and execute the registered object; and an object management apparatus configured to register the received content information as an object, configure a service page for each user, provide a corresponding service page according to a request for the service page by a particular user, and provides one or more sharing services for the registered object.

In accordance with another embodiment of the present disclosure, a service apparatus is provided. The service apparatus includes an information acquiring unit configured to acquire content information selected for each application service; an object registering unit configured to transmit the acquired content information and make a request for registering the content information as an object; and a service access unit configured to receive one or more sharing services of the registered object on a service page through an access to the service page.

Preferably, the information acquiring unit provides a user interface according to an access to an application service and acquires the content information selected for each application service through the user interface.

Preferably, when the object of the content information acquired from a particular application service is registered, the object registering unit additionally transmits access information of the content information and induces the access to the content information based on the access information.

Preferably, when the object of the content information acquired from the particular application service is registered, the object registering unit additionally transmits sharing setting information of the content information to designate a counterpart with which the content information registered as the object is shared based on the sharing setting information or designates a number of times the content information can be moved and added between users when the content information is shared.

Preferably, when the object of the content information acquired from a particular application service is registered, the object registering unit additionally transmits content format information of the content information and allows a format of the content information registered on the service page to be converted based on the content format information.

In accordance with another embodiment of the present disclosure, an object management apparatus is provided. The object management apparatus includes a content information receiver configured to receive content information from a service apparatus acquiring the content information selected for each application service; a page configuration unit configured to register the received content information as an object and configure a service page for each user; and a service provider configured to provide a corresponding service page according to a request for the service page by a particular user and provides one or more sharing services for the registered object.

In accordance with another embodiment of the present disclosure, an object management apparatus is provided. The object management apparatus includes a content information receiver configured to receive acquired content information from a service apparatus acquiring the content information selected for each application service; a page configuration unit configured to register the received content information as an object and configure a service page for each user; and a service provider configured to provide a corresponding service page according to a request for the service page by a particular user and provide one or more sharing services for the registered object.

Preferably, when the object of the content information is registered, the page configuration unit additionally registers access information of the particular content information to configure the service page, and the service provider provides a sharing service between users for the particular content information registered as the object through the service page and induces a user access of the particular content information based on the access information.

Preferably, when the object of the content information is registered, the page configuration unit additionally registers sharing setting information of particular content information and configures the service page, and the service provider limits counterparts with which the particular content information is shared based on the sharing setting information of the particular content information registered as the object on the service page or limits a number of times the particular content information can be moved and added between users when the particular content information is shared.

In accordance with another embodiment of the present disclosure, a personal object sharing method is provided. The personal object sharing method includes acquiring content information selected for each application service by a service apparatus; transmitting the acquired content information and making a request for registering the content information as an object; registering the content information received from the service apparatus as the object and configuring a service page for each user by an object management apparatus; and providing a corresponding service page according to a request for the service page by a particular user and providing one or more sharing services for the registered object by the object management apparatus.

In accordance with another embodiment of the present disclosure, a method of operating a service apparatus is provided. The method includes acquiring content information selected for each application service; transmitting the acquired content information and making a request for registering the content information as an object; and receiving one or more sharing services for the registered object on a service page through an access to the service page.

Preferably, the acquiring of the content information includes providing a user interface according to an access to an application service and acquiring the content information selected for each application service through the user interface.

Preferably, the transmitting of the acquired content information and making of the request for registering the content information as the object includes, when the object for the content information acquired from the particular application service is registered, additionally transmitting access information of the content information and induces an access of the content information based on the access information.

Preferably, the transmitting of the acquired content information and making of the request for registering the content information as the object includes, when the object for the content information acquired from the particular application service is registered, additionally registering sharing setting information of the content information to designate counterparts with which the content information registered as the object is shared based on the sharing setting information or limiting a number of times the content information can be moved and added between users when the content information is shared.

Preferably, the transmitting of the acquired content information and making of the request for registering the content information as the object includes, when the object for the content information acquired from the particular application service is registered, additionally transmitting content format information of the content information and allowing a format of the content information registered on the service page to be converted based on the content format information.

In accordance with another embodiment of the present disclosure, a method of operating an object management apparatus is provided. The method includes receiving acquired content information from a service apparatus acquiring the content information selected for each application service; registering the received content information as an object and configuring a service page for each user; and providing a corresponding service page according to a request for the service page by a particular user and providing one or more sharing services for the registered object.

Preferably, the registering of the received content information as the object and the configuring of the service page for each user, when the object for the content information acquired from the particular application service is registered, additionally transmitting access information of the content information to configure the service page and the providing of the corresponding service page includes providing a sharing service between users for the particular content information registered as the object through the service page and inducing a user access of the particular content information based on the access information.

Preferably, the registering of the received content information as the object and the configuring of the service page for each user includes, when the object for the content information acquired from the particular application service is registered, additionally registering sharing setting information of the content information to configure the service page and the providing of the corresponding service page includes limiting counterparts with which the content information registered as the object on the service page is shared based on the sharing setting information or limiting a number of times the content information can be moved and added between users when the content information is shared.

Preferably, the registering of the received content information as the object and the configuring of the service page for each user includes, when the object for the content information acquired from the particular application service is registered, additionally registering content format information of the particular content information to configure the service page and the providing of the corresponding service page includes converting a format of the particular content information registered as the object based on the content format information according to a format of the service page required for a particular service apparatus.

According to the present disclosure, an inquiry and reuse service for the content information registered as the object can be provided to the accessed user through various service apparatuses by defining the basic object structure for registering the content information designated by a user with respect to each of the various application services as the object, and registering and managing content information for each type as an object by applying an expanded object structure based on the basic object structure according to a type of received content information.

Further, as a mutual sharing function between application services is supported, various demands of application service users can be satisfied and a new application service in a web environment also can be created.

Moreover, according to the present disclosure, as an object sharing function is mutually supported between application services by registering a component of the application service as a sharable object according to a user's designation with respect to each of various application services provided on the web, searching for the registered object, and loading the found object between the application services so as to mutually use the object, various demands of users can be satisfied and a new application service in a web environment also can be created.

Furthermore, according to the present disclosure, as an object sharing function is mutually supported between application services by registering and managing content information designated by a user as an object with respect to each of various application services and providing an inquiry and reuse service of the content information registered as the object to users accessed through various service apparatuses, various demands of users can be satisfied and a new application service in a web environment also can be created.

In addition, according to the present disclosure, it is possible to satisfy various demands of users and also create a new service in a web environment by registering content information according to user's designation as an object to configure a service page and providing a sharing service of the registered object to users who access the corresponding service page when various application services are used.

### BRIEF DESCRIPTION OF THE DRAWINGS

FIG. 1 illustrates a schematic configuration of an object management system according to an embodiment of the present disclosure.

FIG. 2 illustrates a diagram describing an object structure according to an embodiment of the present disclosure.

FIG. 3 illustrates a diagram describing a detailed configuration of an object management apparatus according to an embodiment of the present disclosure.

FIG. 4 illustrates a flowchart describing an object management method according to an embodiment of the present disclosure.

FIG. 5 is a flowchart describing an operation method of an object management apparatus according to an embodiment of the present disclosure.

FIG. 6 illustrates a schematic configuration of an object sharing system according to an embodiment of the present disclosure.

FIG. 7 illustrates a diagram describing a detailed configuration of a service apparatus according to an embodiment of the present disclosure.

FIG. 8 illustrates a diagram describing a detailed configuration of an object management apparatus according to an embodiment of the present disclosure.

FIG. 9 is a flowchart describing an object sharing method according to an embodiment of the present disclosure.

FIG. 10 is a flowchart describing an operation method of a service apparatus according to an embodiment of the present disclosure.

FIG. 11 is a flowchart describing an operation method of an object management apparatus according to an embodiment of the present disclosure.

FIG. 12 illustrates a schematic configuration of a personal object management system according to an embodiment of the present disclosure.

FIG. 13 illustrates a diagram describing a detailed configuration of a service apparatus according to an embodiment of the present disclosure.

FIG. 14 illustrates a diagram describing a detailed configuration of an object management apparatus according to an embodiment of the present disclosure.

FIG. 15 is a flowchart describing a personal object management method according to an embodiment of the present disclosure.

FIG. 16 is a flowchart describing an operation method of a service apparatus according to an embodiment of the present disclosure.

FIG. 17 is a flowchart describing an operation method of an object management apparatus according to an embodiment of the present disclosure.

FIG. 18 illustrates a schematic configuration of a personal object sharing system according to an embodiment of the present disclosure.

FIG. 19 illustrates a diagram describing a detailed configuration of a service apparatus according to an embodiment of the present disclosure.

FIG. 20 illustrates a diagram describing a detailed configuration of an object management apparatus according to an embodiment of the present disclosure.

FIG. 21 is a flowchart describing a personal object sharing method according to an embodiment of the present disclosure.

FIG. 22 is a flowchart describing an operation method of a service apparatus according to an embodiment of the present disclosure.

FIG. 23 is a flowchart describing an operation method of an object management apparatus according to an embodiment of the present disclosure.

### DETAILED DESCRIPTION

Hereinafter, exemplary embodiments of the present disclosure will be described with reference to the accompanying drawings.

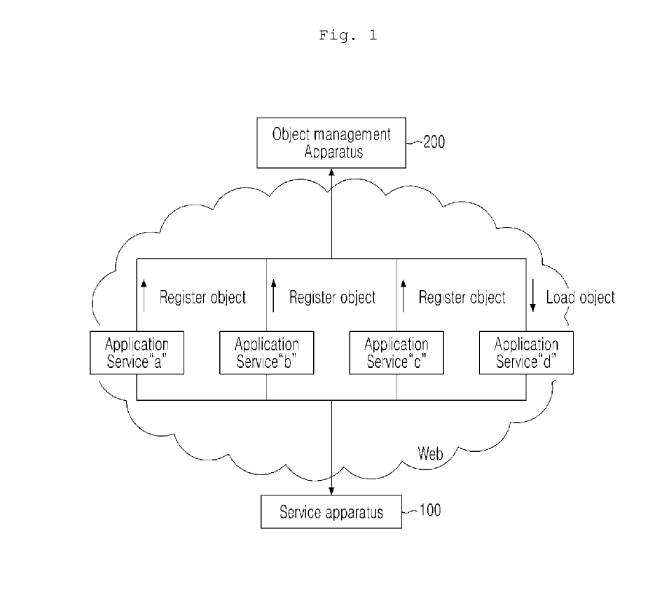

FIG. 1 illustrates a schematic configuration of an object management system according to an embodiment of the present disclosure.

As illustrated in FIG. 1, the system includes a service apparatus 100 that acquires content information selected for each application service and transmits the acquired content information to make a request for registering the content information as an object, and an object management apparatus 200 that identifies the content information received from the service apparatus 100 as an object to register the object, extracts the corresponding object according to the load of the registered object, and provides the extracted object.

The service apparatus 100 refers to a terminal apparatus for accessing various application services through the Web or WAP or by executing an application installed therein, and may correspond to a Personal Computer (PC), a smart phone, and an Internet Protocol TeleVision (IPTV).

Further, the content information acquired from the application service may correspond to one or more driving functions supported by each application service, data generated according to the driving of the application installed to provide each application service, and a content reproduced or shown when each application service is provided.

The service apparatus 100 accesses an application service according to a user's request.

More specifically, the service apparatus 100 accesses application services serviced through the Web or WAP according to a user's request or serviced through the driving of the application installed therein, for example, various types of services such as a personal blog service, a messenger service, a product purchase service, a personal homepage service, a video reproduction service, a music reproduction service, a location based advertisement service, a path finding service, and a Social Networking Service (SNS).

The service apparatus 100 provides a user interface and acquires content information when accessing the application service.

More specifically, when accessing the application service according to a user's request, the service apparatus 100 provides a user interface on a service screen to acquire content information corresponding to the corresponding application service, and acquires content information selected by the user from the service screen through the provided user interface.

For example, when accessing the product purchase service, the service apparatus 100 provides a user interface in a tool bar type on the service screen and receives content information on the service screen by a user's selection on the service screen, that is, a drag and drop action, for example, information on a product purchased by the user or information on a product of interest transmitted through the provided user interface, so as to acquire content information corresponding to the corresponding application service.

The service apparatus 100 transmits the acquired content information to the object management apparatus 200 and registers the content information as an object.

More specifically, in transmitting the content information acquired for each application service to the object management apparatus 200, the service apparatus 100 additionally transmits user identification information (for example, an ID) and thus allows the object management apparatus 200 to register the received content information as the object for each application service corresponding to the user.

When accessing a particular application service, the service apparatus 100 loads and executes a registered object.

More specifically, when receiving an object load request from the user while accessing a particular application service, the service apparatus 100 receives an inquiry service of the object registered for each application from the object management apparatus 200 or loading one or a plurality of objects, so as to allow the loaded objects to be simultaneously executed on the currently accessed application service.

For example, when providing a personal blog service to the accessed user, the service apparatus 100 loads the corresponding object from the object management apparatus 200 according to a user's request for an image editing function registered as the object, and thus allows the image editing function to be additionally shown on the personal blog service and executed on the personal blog service.

Further, when providing a messenger service to the accessed user, the service apparatus 100 loads the corresponding object from the object management apparatus 200 according to a user's request for a viewed video list registered as the object, and thus allows the viewed video list to be transmitted to a conversation counterpart while providing the messenger service.

In addition, when providing a path finding service to the accessed user, the service apparatus 100 loads the corresponding object from the object management apparatus 200 according to a user's request for an advertisement for each situation registered as the object, and thus allows the loaded advertisement for each situation to be shown if the user is located in a corresponding area while providing the path finding service.

Furthermore, when the accessed user makes a request for a plurality of SNS posting functions registered as the objects, the service apparatus 100 loads the plurality of objects from the object management apparatus 200, and thus allows the plurality of SNS posting functions for each production company to be simultaneously shown on a particular site.

The object management apparatus 200 defines a basic object structure to register an object for content information selected for each application service.

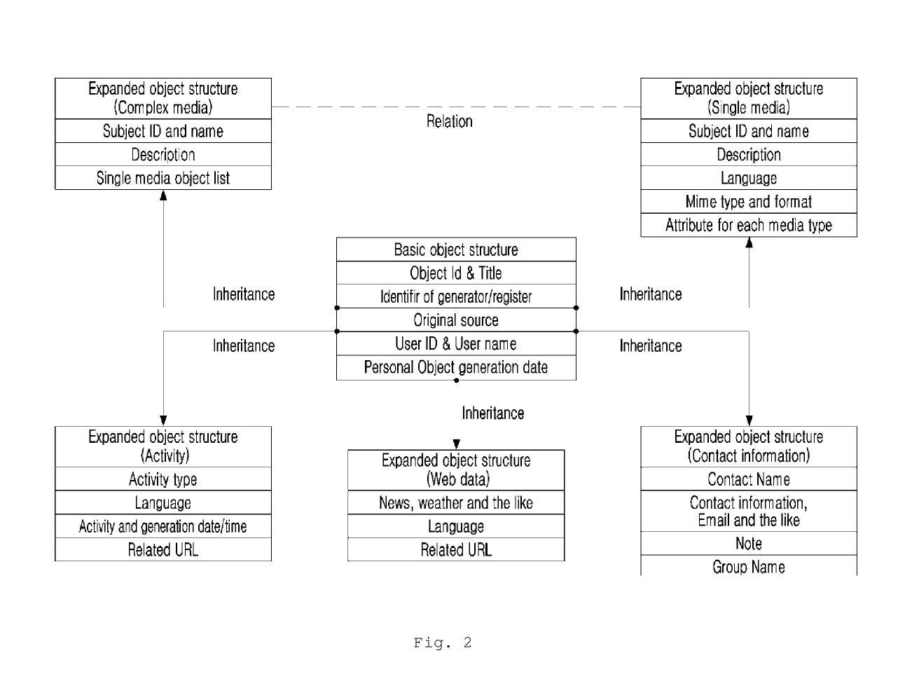

More specifically, as illustrated in FIG. 2, the object management apparatus 200 calculates a basic data structure for combining different data structures according to a type of designated content information, designates configuration parameters (for example, an object ID, an object title, an identifier of a producer/registering unit, an original source URL, a user ID, a user name, and a generation date) corresponding to the calculated basic data structure, and combines the designated configuration parameters, thereby defining the basic object structure.

The object management apparatus 200 sets an expanded object structure based on the basic object structure defined according to the type of designated content information.

More specifically, as illustrated in FIG. 2, the object management apparatus 200 sets the expanded object structure for each type by changing, adding, and deleting each of the configuration parameters designated to the basic object structure defined according to the type of designated content information which is divided into complex media (for example, video series, an image group, and an album), single media (for example, an individual video included in particular video series, an individual image included in a particular image group, and a song included in a particular album), activity according to the use of a plurality of application services by the user, web data (for example, news and weather), and contact information.

In other words, the object management apparatus 200 sets the expanded object structure corresponding to the complex media by combining the configuration parameters such as “subject ID and name”, “description”, and “single media object list”, and sets the expanded object structure corresponding to the single media associated with the complex media by combining the configuration parameters such as “subject ID and name”, “description”, “language”, “MIME type and format”, and “attribute for each media type”.

Further, the object management apparatus 200 sets the expanded object structure corresponding to the activity by combining the configuration parameters such as “activity type”, “language”, “activity alc generation date/time”, and “related URL”, and sets the expanded object structure corresponding to the contact information by combining the configuration parameters such as “contents name”, “contact information”, “note”, and “group name”.

The object management apparatus 200 receives content information selected when the service apparatus 100 accesses the application service.

More specifically, the object management apparatus 200 receives the content information for each application acquired through the user interface on the application service screen from the service apparatus 100.

The object management apparatus 200 identifies a type of content information received from the service apparatus 100 and registers the content information as the object by applying the expanded object structure corresponding to the identified type.

More specifically, the object management apparatus 200 identifies the type of content information received from the service apparatus 100 and selects the expanded object structure corresponding to the identified type of content information among the expanded object structures set according to the type of designated content information.

At this time, the object management apparatus 200 identifies the type of content information received from the service apparatus 100 and selects the expanded object structure corresponding to the identified type of content information among the expanded object structures set according to the type of designated content information.

Further, the object management apparatus 200 analyzes the received content information to extract attribute data constituting the content information and inserts the extracted attribute data into the configuration parameter designated to the selected expanded object structure, so as to register the object.

For example, when the identified type of content information is the complex media, the object management apparatus 200 registers the object corresponding to the complex media by selecting the expanded object structure corresponding to the complex media and inserting the attribute data extracted from the corresponding content information into the configuration parameters designated to the selected expanded object structure, that is, “subject ID and name”, “description”, and “single media object list”.

Further, when the identified type of content information is the single media, the object management apparatus 200 registers the object corresponding to the single media by selecting the expanded object structure corresponding to the single media and inserting the attribute data extracted from the corresponding content information into the configuration parameters designated to the selected expanded object structure, that is, “subject ID and name”, “description”, “language”, “MIME type and format”, and “attribute for each media type”.

In addition, when the identified type of content information is the activity, the object management apparatus 200 registers the object corresponding to the activity by selecting the expanded object structure corresponding to the activity and inserting the attribute data extracted from the corresponding content information into the configuration parameters designated to the selected expanded object structure, that is, “activity type”, “language”, “activity alc generation date/time”, and “related URL”.

Furthermore, when the identified type of content information is the web data, the object management apparatus 200 registers the object corresponding to the web data by selecting the expanded object structure corresponding to the web data and inserting the attribute data extracted from the corresponding content information into the configuration parameters designated to the selected expanded object structure, that is, “web data type”, “language”, and “related URL”.

Moreover, when the identified type of content information is the contact information, the object management apparatus 200 registers the object corresponding to the contact information by selecting the expanded object structure corresponding to the contact information and inserting the attribute data extracted from the corresponding content information into the configuration parameters designated to the selected expanded object structure, that is, “contents name”, “contact information”, “note”, and “group name”.

The object management apparatus 200 extracts and provides the corresponding object according to the load of the registered object.

More specifically, when receiving an object load request from the service apparatus 100 which accesses a particular application service, the object management apparatus 200 provides an inquiry service of the registered object in accordance with the corresponding user or extracts and then provides one or a plurality of objects, so as to allow the provided objects to be simultaneously executed on the currently accessed application service.

For example, when an image editing function registered as the object is loaded by the service apparatus 100 which provides a personal blog service to the accessed user, the object management apparatus 200 extracts and provides the corresponding object to the service apparatus 100, so as to allow the image editing function to be additionally shown on the personal blog service serviced through the service apparatus 100.

Further, when a viewed video list registered as the object is loaded by the service apparatus 100 which provides a messenger service to the accessed user, the object management apparatus 200 extracts and provides the corresponding object to the service apparatus 100, so as to allow the viewed video list to be transmitted to a conversation counterpart while providing the messenger service.

Furthermore, when an advertisement for each situation registered as the object is loaded by the service apparatus 100 which provides a path finding service to the accessed user, the object management apparatus 200 extracts and provides the corresponding object to the service apparatus 100, so as to allow the advertisement for each situation to be shown if the user is located in a corresponding area while providing the path finding service.

In addition, when a plurality of SNS posting functions registered as the objects are loaded by the service apparatus 100, the object management apparatus 200 extracts and provides the plurality of registered objects, so as to allow the plurality of SNS posting functions for each production company to be simultaneously shown on a particular site serviced through the service apparatus 100.

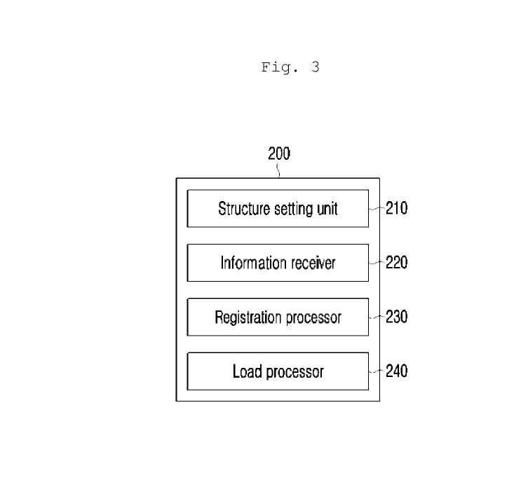

Hereinafter, a more detailed configuration of the object management apparatus 200 according to an embodiment of the present disclosure will be described with reference to FIG. 3.

As illustrated in FIG. 3, the object management apparatus 200 includes a structure setting unit 210, an information receiver 220 that receives content information from the service apparatus 100, a registration processor 230 that registers the received content information as an object, and a load processor 240 that extracts and provides the loaded object.

The structure setting unit 210 defines a basic object structure to register an object for content information selected for each application service.

More specifically, as illustrated in FIG. 2, the structure setting unit 210 calculates a basic data structure for combining different data structures according to a type of designated content information, designates configuration parameters (for example, an object ID, an object title, an identifier of a producer/registering unit, an original source URL, a user ID, a user name, and a generation date) corresponding to the calculated basic data structure, and combines the designated configuration parameters, thereby defining the basic object structure.

The structure setting unit 210 sets an expanded object structure based on the basic object structure defined according to the type of designated content information.

More specifically, as illustrated in FIG. 2, the structure setting unit 210 sets the expanded object structure for each type by changing, adding, and deleting each of the configuration parameters designated to the basic object structure defined according to the type of designated content information which is divided into complex media (for example, video series, an image group, and an album), single media (for example, an individual video included in particular video series, an individual image included in a particular image group, and a song included in a particular album), activity according to the use of a plurality of application services by the user, web data (for example, news and weather), and contact information.

In other words, the structure setting unit 210 sets the expanded object structure corresponding to the complex media by combining the configuration parameters such as “subject ID and name”, “description”, and “single media object list”, and sets the expanded object structure corresponding to the single media associated with the complex media by combining the configuration parameters such as “subject ID and name”, “description”, “language”, “MIME type and format”, and “attribute for each media type”.

Further, the structure setting unit 210 sets the expanded object structure corresponding to the activity by combining the configuration parameters such as “activity type”, “language”, “activity alc generation date/time”, and “related URL”, and sets the expanded object structure corresponding to the contact information by combining the configuration parameters such as “contents name”, “contact information”, “note”, and “group name”.

The information receiver 220 receives content information selected when the service apparatus 100 accesses the application service.

More specifically, the information receiver 220 receives the content information for each application acquired through the user interface on the application service screen from the service apparatus 100.

The registration processor 230 identifies a type of content information received from the service apparatus 100 and registers the content information as the object by applying the expanded object structure corresponding to the identified type.

More specifically, the registration processor 230 identifies the type of content information received from the service apparatus 100 and selects the expanded object structure corresponding to the identified type of content information among the expanded object structures set according to the type of designated content information.

Further, the registration processor 230 analyzes the received content information to extract attribute data constituting the content information and inserts the extracted attribute data into the configuration parameter designated to the selected expanded object structure, so as to register the object.

For example, when the identified type of content information is the complex media, the registration processor 230 registers the object corresponding to the complex media by selecting the expanded object structure corresponding to the complex media and inserting the attribute data extracted from the corresponding content information into the configuration parameters designated to the selected expanded object structure, that is, “subject ID and name”, “description”, and “single media object list”.

Further, when the identified type of content information is the single media, the registration processor 230 registers the object corresponding to the single media by selecting the expanded object structure corresponding to the single media and inserting the attribute data extracted from the corresponding content information into the configuration parameters designated to the selected expanded object structure, that is, “subject ID and name”, “description”, “language”, “MIME type and format”, and “attribute for each media type”.

In addition, when the identified type of content information is the activity, the registration processor 230 registers the object corresponding to the activity by selecting the expanded object structure corresponding to the activity and inserting the attribute data extracted from the corresponding content information into the configuration parameters designated to the selected expanded object structure, that is, “activity type”, “language”, “activity alc generation date/time”, and “related URL”.

Furthermore, when the identified type of content information is the web data, the registration processor 230 registers the object corresponding to the web data by selecting the expanded object structure corresponding to the web data and inserting the attribute data extracted from the corresponding content information into the configuration parameters designated to the selected expanded object structure, that is, “web data type”, “language”, and “related URL”.

Moreover, when the identified type of content information is the contact information, the registration processor 230 registers the object corresponding to the contact information by selecting the expanded object structure corresponding to the contact information and inserting the attribute data extracted from the corresponding content information into the configuration parameters designated to the selected expanded object structure, that is, “contents name”, “contact information”, “note”, and “group name”.

The load processor 240 extracts and provides the corresponding object according to the load of the registered object.

More specifically, when receiving an object load request from the service apparatus 100 which accesses a particular application service, the load processor 240 provides an inquiry service of the registered object in accordance with the corresponding user or extracts and then provides one or a plurality of objects, so as to allow the provided objects to be simultaneously executed on the currently accessed application service.

For example, when an image editing function registered as the object is loaded by the service apparatus 100 which provides a personal blog service to the accessed user, the load processor 240 extracts and provides the corresponding object to the service apparatus 100, so as to allow the image editing function to be additionally shown on the personal blog service serviced through the service apparatus 100.

Further, when a viewed video list registered as the object is loaded by the service apparatus 100 which provides a messenger service to the accessed user, the load processor 240 extracts and provides the corresponding object to the service apparatus 100, so as to allow the viewed video list to be transmitted to a conversation counterpart while providing the messenger service.

Furthermore, when an advertisement for each situation registered as the object is loaded by the service apparatus 100 which provides a path finding service to the accessed user, the load processor 240 extracts and provides the corresponding object to the service apparatus 100, so as to allow the advertisement for each situation to be shown if the user is located in a corresponding area while providing the path finding service.

In addition, when a plurality of SNS posting functions registered as the objects are loaded by the service apparatus 100, the load processor 240 extracts and provides the plurality of registered objects, so as to allow the plurality of SNS posting functions for each production company to be simultaneously shown on a particular site serviced through the service apparatus 100.

As described above, according to the object management system of the present disclosure, an inquiry and reuse service for the content information registered as the object can be provided to the accessed user through various service apparatuses by defining the basic object structure for registering the content information designated for each of the various application services by the user as the object, and registering and managing content information for each type as each object by applying an expanded object structure based on the basic object structure according to a type of the received content information, so as to provide inquiry and reuse services of the content information registered as the object to the user accessed through various service apparatuses. Further, as a mutual sharing function between application services is supported, various demands of application service users can be satisfied and a new application service in a web environment also can be created.

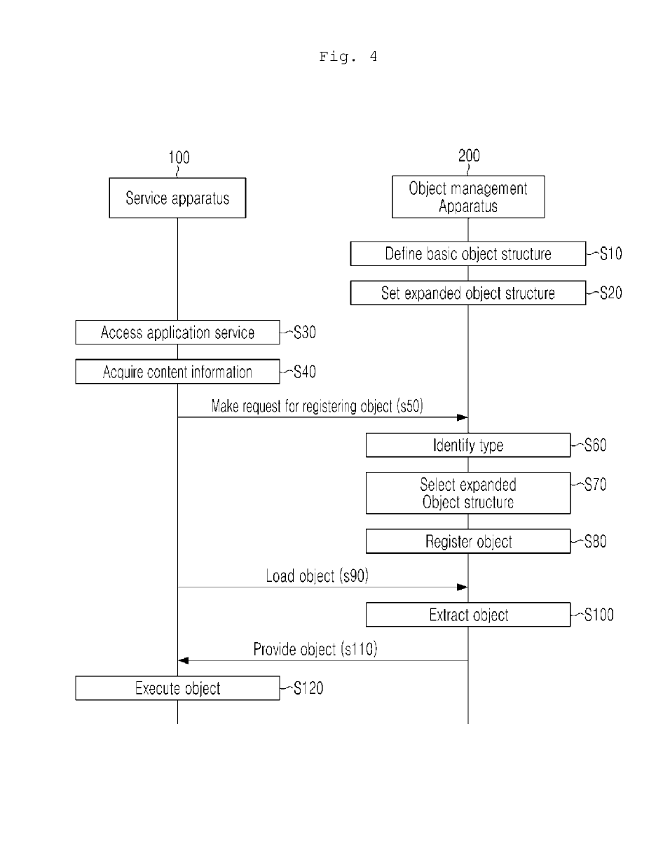

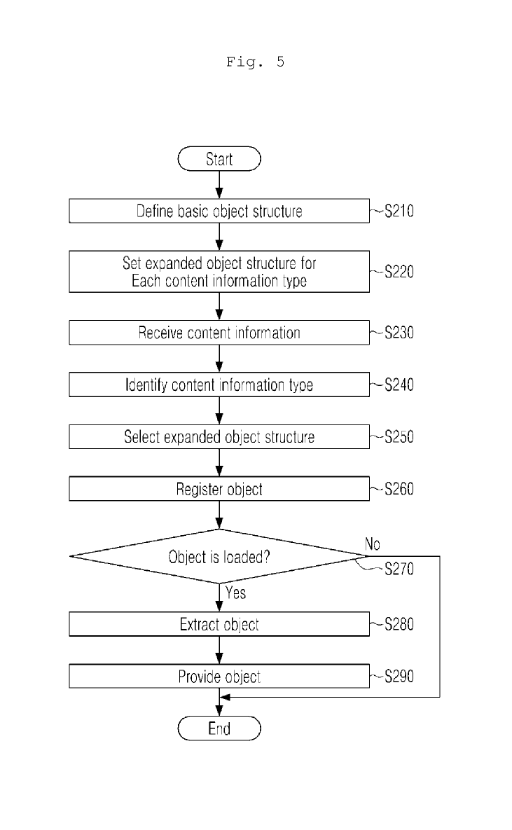

Hereinafter, an object management method according to an embodiment of the present disclosure will be described with reference to FIGS. 4 and 5. The same configurations as those illustrated in FIGS. 1 to 3 are assigned the same corresponding reference numerals for the convenience of description.

First, an operation method of the object management system according to an embodiment of the present disclosure will be described with reference to FIG. 4.

The object management apparatus 200 defines a basic object structure to register an object for content information selected for each application service in S10.

Preferably, as illustrated in FIG. 2, the object management apparatus 200 calculates a basic data structure for combining different data structures according to a type of designated content information, designates configuration parameters (for example, an object ID, an object title, an identifier of a producer/registering unit, an original source URL, a user ID, a user name, and a generation date) corresponding to the calculated basic data structure, and combines the designated configuration parameters, thereby defining the basic object structure.

Then, the object management apparatus 200 sets an expanded object structure based on the basic object structure defined according to the type of designated content information in S20.

Preferably, as illustrated in FIG. 2, the object management apparatus 200 sets the expanded object structure for each type by changing, adding, and deleting each of the configuration parameters designated to the basic object structure defined according to the type of designated content information which is divided into complex media (for example, video series, an image group, and an album), single media (for example, an individual video included in particular video series, an individual image included in a particular image group, and a song included in a particular album), activity according to the use of a plurality of application services by the user, web data (for example, news and weather), and contact information.

In other words, the object management apparatus 200 sets the expanded object structure corresponding to the complex media by combining the configuration parameters such as “subject ID and name”, “description”, and “single media object list”, and sets the expanded object structure corresponding to the single media associated with the complex media by combining the configuration parameters such as “subject ID and name”, “description”, “language”, “MIME type and format”, and “attribute for each media type”.

Further, the object management apparatus 200 sets the expanded object structure corresponding to the activity by combining the configuration parameters such as “activity type”, “language”, “activity alc generation date/time”, and “related URL”, and sets the expanded object structure corresponding to the contact information by combining the configuration parameters such as “contents name”, “contact information”, “note”, and “group name”.

Thereafter, the service apparatus 100 accesses an application service according to a user's request in S30.

Preferably, the service apparatus 100 accesses application services serviced through the Web or WAP according to a user's request or serviced through the driving of the application installed therein, for example, various types of services such as a personal blog service, a messenger service, a product purchase service, a personal homepage service, a video reproduction service, a music reproduction service, a location based advertisement service, a path finding service, and a Social Networking Service (SNS).

Then, the service apparatus 100 provides a user interface and acquires content information when accessing the application service in S40.

Preferably, when accessing the application service according to a user's request, the service apparatus 100 provides a user interface on a service screen to acquire content information corresponding to the corresponding application service, and acquires content information selected by the user from the service screen through the provided user interface.

For example, when accessing the product purchase service, the service apparatus 100 provides a user interface in a tool bar type on the service screen and receives content information on the service screen by a user's selection on the service screen, that is, a drag and drop action, for example, information on a product purchased by the user or information on a product of interest transmitted through the provided user interface, so as to acquire content information corresponding to the corresponding application service.

Then, the service apparatus 100 transmits the acquired content information to the object management apparatus 200 and registers the content information as an object in S50.

Preferably, in transmitting the content information acquired for each application service to the object management apparatus 200, the service apparatus 100 additionally transmits user identification information (for example, an ID) and thus allows the object management apparatus 200 to register the received content information as the object for each application service corresponding to the user.

Subsequently, the object management apparatus 200 identifies a type of content information received from the service apparatus 100 and registers the content information as the object by applying the expanded object structure corresponding to the identified type in S60 to S80.

Preferably, the object management apparatus 200 identifies the type of content information received from the service apparatus 100 and selects the expanded object structure corresponding to the identified type of content information among the expanded object structures set according to the type of designated content information.

At this time, the object management apparatus 200 identifies the type of content information received from the service apparatus 100 and selects the expanded object structure corresponding to the identified type of content information among the expanded object structures set according to the type of designated content information.

Further, the object management apparatus 200 analyzes the received content information to extract attribute data constituting the content information and inserts the extracted attribute data into the configuration parameter designated to the selected expanded object structure, so as to register the object.

For example, when the identified type of content information is the complex media, the object management apparatus 200 registers the object corresponding to the complex media by selecting the expanded object structure corresponding to the complex media and inserting the attribute data extracted from the corresponding content information into the configuration parameters designated to the selected expanded object structure, that is, “subject ID and name”, “description”, and “single media object list”.

Further, when the identified type of content information is the single media, the object management apparatus 200 registers the object corresponding to the single media by selecting the expanded object structure corresponding to the single media and inserting the attribute data extracted from the corresponding content information into the configuration parameters designated to the selected expanded object structure, that is, “subject ID and name”, “description”, “language”, “MIME type and format”, and “attribute for each media type”.

In addition, when the identified type of content information is the activity, the object management apparatus 200 registers the object corresponding to the activity by selecting the expanded object structure corresponding to the activity and inserting the attribute data extracted from the corresponding content information into the configuration parameters designated to the selected expanded object structure, that is, “activity type”, “language”, “activity alc generation date/time”, and “related URL”.

Furthermore, when the identified type of content information is the web data, the object management apparatus 200 registers the object corresponding to the web data by selecting the expanded object structure corresponding to the web data and inserting the attribute data extracted from the corresponding content information into the configuration parameters designated to the selected expanded object structure, that is, “web data type”, “language”, and “related URL”.

Moreover, when the identified type of content information is the contact information, the object management apparatus 200 registers the object corresponding to the contact information by selecting the expanded object structure corresponding to the contact information and inserting the attribute data extracted from the corresponding content information into the configuration parameters designated to the selected expanded object structure, that is, “contents name”, “contact information”, “note”, and “group name”.

Thereafter, when accessing a particular application service, the service apparatus 100 loads and executes a registered object in S90 to S120.

Preferably, when receiving an object load request from the user while accessing a particular application service, the service apparatus 100 receives an inquiry service of the object registered for each application from the object management apparatus 200 or loads one or a plurality of objects, so as to allow the loaded objects to be simultaneously executed on the currently accessed application service.

For example, when providing a personal blog service to the accessed user, the service apparatus 100 loads the corresponding object from the object management apparatus 200 according to a user's request for an image editing function registered as the object, and thus allows the image editing function to be additionally shown on the personal blog service and executed on the personal blog service.

Further, when providing a messenger service to the accessed user, the service apparatus 100 loads the corresponding object from the object management apparatus 200 according to a user's request for a viewed video list registered as the object, and thus allows the viewed video list to be transmitted to a conversation counterpart while providing the messenger service.

In addition, when providing a path finding service to the accessed user, the service apparatus 100 loads the corresponding object from the object management apparatus 200 according to a user's request for an advertisement for each situation registered as the object, and thus allows the loaded advertisement for each situation to be shown if the user is located in a corresponding area while providing the path finding service.

Furthermore, when the accessed user makes a request for a plurality of SNS posting functions registered as the objects, the service apparatus 100 loads the plurality of objects from the object management apparatus 200, and thus allows the plurality of SNS posting functions for each production company to be simultaneously shown on a particular site.

Hereinafter, the operation method of the object management apparatus 200 according to an embodiment of the present disclosure will be described with reference to FIG. 5.

First, a basic object structure is defined to register an object for content information selected for each application service in S210.

Preferably, as illustrated in FIG. 2, the structure setting unit 210 calculates a basic data structure for combining different data structures according to a type of designated content information, designates configuration parameters (for example, an object ID, an object title, an identifier of a producer/registering unit, an original source URL, a user ID, a user name, and a generation date) corresponding to the calculated basic data structure, and combines the designated configuration parameters, thereby defining the basic object structure.

Then, an expanded object structure is set based on the basic object structure defined according to the type of designated content information in S220.

Preferably, as illustrated in FIG. 2, the expanded object structure for each type is set by changing, adding, and deleting each of the configuration parameters designated to the basic object structure defined according to the type of designated content information which is divided into complex media (for example, video series, an image group, and an album), single media (for example, an individual video included in particular video series, an individual image included in a particular image group, and a song included in a particular album), activity according to the use of a plurality of application services by the user, web data (for example, news and weather), and contact information.

In other words, the structure setting unit 210 sets the expanded object structure corresponding to the complex media by combining the configuration parameters such as “subject ID and name”, “description”, and “single media object list”, and sets the expanded object structure corresponding to the single media associated with the complex media by combining the configuration parameters such as “subject ID and name”, “description”, “language”, “MIME type and format”, and “attribute for each media type”.

Further, the structure setting unit 210 sets the expanded object structure corresponding to the activity by combining the configuration parameters such as “activity type”, “language”, “activity alc generation date/time”, and “related URL”, and sets the expanded object structure corresponding to the contact information by combining the configuration parameters such as “contents name”, “contact information”, “note”, and “group name”.

Then, the selected content information is received when the service apparatus 100 accesses the application service in S230.

Preferably, the information receiver 220 receives the content information for each application acquired through the user interface on the application service screen from the service apparatus 100.

Subsequently, a type of content information received from the service apparatus 100 is identified and the content information is registered as the object by applying the expanded object structure corresponding to the identified type in S240 to S260.

Preferably, the registration processor 230 identifies the type of content information received from the service apparatus 100 and selects the expanded object structure corresponding to the identified type of content information among the expanded object structures set according to the type of designated content information.

Further, the registration processor 230 analyzes the received content information to extract attribute data constituting the content information and inserts the extracted attribute data into the configuration parameter designated to the selected expanded object structure, so as to register the object.

For example, when the identified type of content information is the complex media, the registration processor 230 registers the object corresponding to the complex media by selecting the expanded object structure corresponding to the complex media and inserting the attribute data extracted from the corresponding content information into the configuration parameters designated to the selected expanded object structure, that is, “subject ID and name”, “description”, and “single media object list”.

Further, when the identified type of content information is the single media, the registration processor 230 registers the object corresponding to the single media by selecting the expanded object structure corresponding to the single media and inserting the attribute data extracted from the corresponding content information into the configuration parameters designated to the selected expanded object structure, that is, “subject ID and name”, “description”, “language”, “MIME type and format”, and “attribute for each media type”.

Further, when the identified type of content information is the single media, the registration processor 230 registers the object corresponding to the single media by selecting the expanded object structure corresponding to the single media and inserting the attribute data extracted from the corresponding content information into the configuration parameters designated to the selected expanded object structure, that is, “subject ID and name”, “description”, “language”, “MIME type and format”, and “attribute for each media type”.

In addition, when the identified type of content information is the activity, the registration processor 230 registers the object corresponding to the activity by selecting the expanded object structure corresponding to the activity and inserting the attribute data extracted from the corresponding content information into the configuration parameters designated to the selected expanded object structure, that is, “activity type”, “language”, “activity alc generation date/time”, and “related URL”.

Furthermore, when the identified type of content information is the web data, the registration processor 230 registers the object corresponding to the web data by selecting the expanded object structure corresponding to the web data and inserting the attribute data extracted from the corresponding content information into the configuration parameters designated to the selected expanded object structure, that is, “web data type”, “language”, and “related URL”.

Moreover, when the identified type of content information is the contact information, the registration processor 230 registers the object corresponding to the contact information by selecting the expanded object structure corresponding to the contact information and inserting the attribute data extracted from the corresponding content information into the configuration parameters designated to the selected expanded object structure, that is, “contents name”, “contact information”, “note”, and “group name”.

Thereafter, according to the load of the registered object, the corresponding object is extracted and provided in S270 to S290.

Preferably, when receiving an object load request from the service apparatus 100 which accesses a particular application service, the load processor 240 provides an inquiry service of the registered object in accordance with the corresponding user or extracts and then provides one or a plurality of objects, so as to allow the provided objects to be simultaneously executed on the currently accessed application service.

For example, when an image editing function registered as the object is loaded by the service apparatus 100 which provides a personal blog service to the accessed user, the load processor 240 extracts and provides the corresponding object to the service apparatus 100, so as to allow the image editing function to be additionally shown on the personal blog service serviced through the service apparatus 100.

Further, when a viewed video list registered as the object is loaded by the service apparatus 100 which provides a messenger service to the accessed user, the load processor 240 extracts and provides the corresponding object to the service apparatus 100, so as to allow the viewed video list to be transmitted to a conversation counterpart while providing the messenger service.

Furthermore, when an advertisement for each situation registered as the object is loaded by the service apparatus 100 which provides a path finding service to the accessed user, the load processor 240 extracts and provides the corresponding object to the service apparatus 100, so as to allow the advertisement for each situation to be shown if the user is located in a corresponding area while providing the path finding service.

In addition, when a plurality of SNS posting functions registered as the objects are loaded by the service apparatus 100, the load processor 240 extracts and provides the plurality of registered objects, so as to allow the plurality of SNS posting functions for each production company to be simultaneously shown on a particular site serviced through the service apparatus 100.

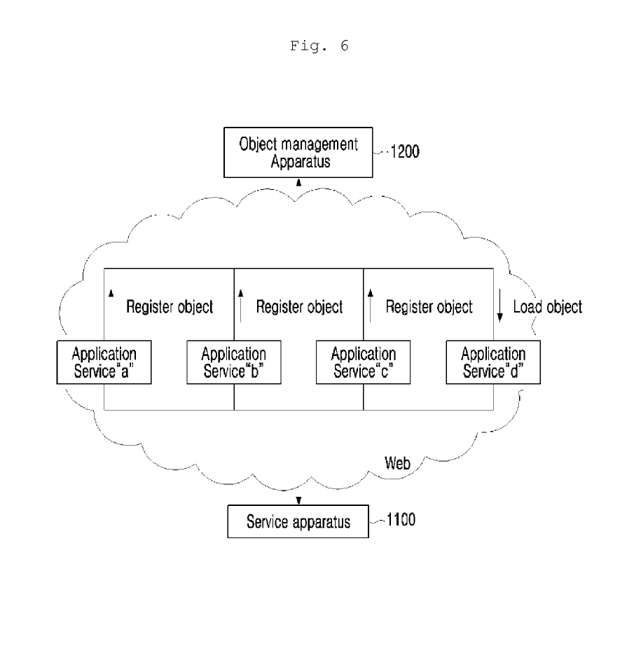

FIG. 6 illustrates a schematic configuration of an object sharing system according to an embodiment of the present disclosure.

As illustrated in FIG. 6, the system includes a service apparatus 1100 that transmits service information according to a user's designation in accordance with an application service and makes a request for registering the service information as an object, and an object management apparatus 1200 that registers the service information received from the service apparatus 1100 as the object, and extracts and provides an object registered for each user according to a request of the service apparatus 1100.

The service apparatus 1100 provides an application service to the accessed user.

More specifically, the service apparatus 1100 provides a single application service or a plurality of application services to the accessed user through the Web.

The application service refers to various services provided on the corresponding Web according to the driving of an installed application, and may correspond to various types of services, for example, a personal blog service, a messenger service, a product purchase service, a personal homepage service, a video reproduction service, a music reproduction service, a location based advertisement service, a path finding service, and an SNS service.

Further, the service apparatus 1100 transmits the service information corresponding to the application service to make a request for registering the service information as the object.

More specifically, in providing each application service to the accessed user, the service apparatus 1100 extracts service information according to the user's designation and transmits the extracted service information to the object management apparatus 1200, so as to register the service information as the object for sharing between the service applications.

The service information may correspond to one or more driving functions supported by the installed application to provide each application service, data generated according to the driving of the installed application to provide each application service, and a content reproduced or shown when each application service is provided.

At this time, in registering the object of the service information, the service apparatus 1100 additionally transmits type information for distinguishing a type of service information, for example, an application function type, a data type, and a content type, an execution environment of the corresponding application service from which the service information is extracted, for example, a driving OS, service identification information for identifying a capability of the service apparatus executing the application service, and sharing setting information for designating a target to share each object, for example, a service provider, an individual, a national organization, and development company, so as to register each object such that the additionally received matters are mapped into the objects on the object management apparatus 1200.

For example, in providing the personal homepage service to the accessed user in connection with one or more driving functions supported by the aforementioned application, the service apparatus 1100 extracts the corresponding function as the service information and transmits the extracted function to the object management apparatus 1200 according to the user's designation, so as to register the image editing function as the object.

Further, in providing the video reproduction service to the accessed user in connection with the data generated according to the driving of the aforementioned application, the service apparatus 1100 extracts the corresponding data as the service information and transmits the extracted data to the object management apparatus 1200 according to the user's designation for the viewed video list, so as to register the viewed video list as the object.

In addition, in providing the advertisement service to the accessed user in connection with the content reproduced or shown when the aforementioned service is provided, the service apparatus 1100 extracts the corresponding content as the service information and transmits the extracted content to the object management apparatus 1200 according to the user's designation for the advertisement for each situation provided based on a particular area, so as to register the image editing function as the object.

Furthermore, the service apparatus 1100 loads and executes the registered object when the application service is provided.

More specifically, when a request for sharing the object is made by the user when a new application service is provided to the accessed user, the service apparatus 1100 receives a search list of the registered object from the object management apparatus 1200 and loads one or a plurality of objects based on the received search list, so as to execute the loaded object on the currently provided application service.

At this time, as the service apparatus 1100 transmits type information on the object to be shared to the object management apparatus 1200, the service apparatus 1100 may be implemented to receive the search list of the object selected based on the type information on the transmitted object from the object management apparatus 1200.

Further, as the service apparatus 1100 transmits the type information and the service identification information for identifying an execution environment of a currently provided particular application service when making the request for sharing the object, the service apparatus 1100 may be implemented to receive the search list for the object selected to simultaneously satisfy the type information on the transmitted object and the execution environment of the particular application service or the search list for the object of which a data conversion is performed to satisfy the execution environment from the object management apparatus 1200.

In addition, when making the request for sharing the object, the service apparatus 1100 may be implemented to receive the search list for the object that satisfies the type information on the transmitted object and the execution environment of the particular application service and satisfies sharing setting information in which a subject to share counterpart with which each object can be shared is set at the same time from the object management apparatus 1200.

For example, when providing the personal blog service to the accessed user, the service apparatus 1100 loads the corresponding object from the object management apparatus 1200 according to a user's request for an image editing function registered as the object, and thus allows the image editing function to be additionally shown on the personal blog service and executed on the personal blog service.

Further, when providing the messenger service to the accessed user, the service apparatus 1100 loads the corresponding object from the object management apparatus 1200 according to a user's request for sharing the viewed video list registered as the object, and thus allows the viewed video list to be transmitted to a conversation counterpart while providing the messenger service.

In addition, when providing the path finding service to the accessed user, the service apparatus 1100 loads the corresponding object from the object management apparatus 1200 according to a user's request for an advertisement for each situation registered as the object, and thus allows the loaded advertisement for each situation to be exposed if the user is located in a corresponding area in while providing the path finding service.

Furthermore, when the service apparatus 1100 receives a request for a plurality of SNS posting functions registered as the objects from the accessed user, the service apparatus 1100 loads the plurality of objects from the object management apparatus 1200, and thus allows the plurality of SNS posting functions for each production company to be simultaneously shown on a particular site.

The object management apparatus 1200 receives service information designated to correspond to the application service from the service apparatus 1100 and registers the received service information as the object for each user.

More specifically, the object management apparatus 1200 receives service information extracted according to the user's designation from the service apparatus 1100 which provides the application service to the accessed user and registers the received service information as the object for each user, so as to allow the registered object to be shared between the application services.

The service information registered as the object may correspond to one or more driving functions supported by the installed application to provide each application service, data generated according to the driving of the installed application to provide each application service, and a content reproduced or exposed when each application service is provided.

At this time, in registering the object of the service information, the object management apparatus 1200 additionally receives type information for distinguishing a type of service information, for example, an application function type, a data type, and a content type, an execution environment of the corresponding application service from which the service information is extracted, for example, a driving OS, service identification information for identifying a capability of the service apparatus executing the application service, and sharing setting information for designating a target to share each object, for example, a service provider, an individual, a national organization, and development company from the service apparatus 1100, so as to register each object such that the additionally received matters are mapped to the objects.

For example, when the service apparatus 1100 provides a personal homepage service to the accessed user in connection with one or more driving functions supported by the aforementioned application, the object management apparatus 1200 receives an image editing function for registering and editing a picture from the service apparatus as service information and registers the received image editing function as the object.

Further, when the service apparatus 1100 provides a video reproduction service to the accessed user in connection with data generated according to the driving of the aforementioned application, the object management apparatus 1200 receives a viewed video list from the service apparatus 1100 as service information and registers the received viewed video list as the object.

In addition, when the service apparatus 1100 provides an advertisement service to the accessed user in connection with a content reproduced or shown in providing the aforementioned application, the object management apparatus 1200 receives an advertisement for each situation provided in connection with a particular area from the service apparatus 1100 as service information and registers the received advertisement as the object.

Further, when receiving an object sharing request from the service apparatus 1100, the object management apparatus 1200 selects the registered object and provides a search list.

More specifically, when the object sharing request is made by the service apparatus 1100 that provides a new application service to the accessed user, the object management apparatus 1200 provides the search list of the registered object to the service apparatus 1100.

At this time, when the object management apparatus 1200 additionally receives type information on the object to be shared in receiving the object sharing request from the service apparatus 1100, the object management apparatus 1200 may select an object that matches the type information on the received object and provide a search list of the selected object to the service apparatus 1100.

Further, when the object management apparatus 1200 additionally receives service identification information for identifying an execution environment of a particular application service currently provided by the service apparatus 1100 together with the type information on the object to be shared in receiving the object sharing request from the service apparatus 1100, the object management apparatus 1200 may provide a search list of the object selected to simultaneously satisfy the type information and the execution environment of the particular application service or object of which a data conversion is performed to satisfy the execution environment.

In addition, when the object management apparatus 1200 receives the object sharing request from the service apparatus 1100, the object management apparatus 1200 selects the object that satisfies the execution information and the execution environment of the particular application and additionally satisfies sharing setting information in which a counterpart with which each object can be shared is set and provides a search list of the selected object by identifying the service apparatus 1100 transmitting the object sharing request.

Furthermore, the object management apparatus 1200 extracts and provides the loaded object.

More specifically, when one or a plurality of objects are loaded based on the provided search list, the object management apparatus 1200 extracts and provides the corresponding object, so as to allow the object provided on the application service currently provided by the service apparatus 1100 to be additionally executed.

For example, when an image editing function registered as the object is loaded by the service apparatus 1100 which provides a personal blog service to the accessed user, the object management apparatus 1200 extracts and provides the corresponding object to the service apparatus 1100, so as to allow the image editing function to be additionally shown on the personal blog service serviced through the service apparatus 1100.

Further, when a viewed video list registered as the object is loaded by the service apparatus 1100 which provides a messenger service to the accessed user, the object management apparatus 1200 extracts and provides the corresponding object to the service apparatus 1100, so as to allow the viewed video list to be transmitted to a conversation counterpart while providing the messenger service.

Furthermore, when an advertisement for each situation registered as the object is loaded by the service apparatus 1100 which provides a path finding service to the accessed user, the object management apparatus 1200 extracts and provides the corresponding object to the service apparatus 1100, so as to allow the advertisement for each situation to be shown if the user is located in a corresponding area while providing the path finding service.

In addition, when a plurality of SNS posting functions registered as the objects are loaded by the service apparatus 1100, the object management apparatus 1200 extracts and provides the plurality of registered objects, so as to allow the plurality of SNS posting functions for each production company to be simultaneously shown on a particular site serviced through the service apparatus 1100.

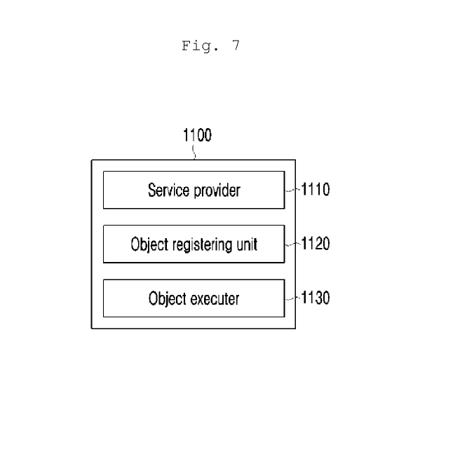

Hereinafter, a more detailed configuration of the service apparatus 1100 according to an embodiment of the present disclosure will be described with reference to FIG. 7.

As illustrated in FIG. 7, the service apparatus 1100 includes a service provider 1110 that provides an application service to the accessed user, an object registering unit 1120 that extracts service information and registers the service information as an object, and an object executer 1130 that loads and executes the registered object.

The service apparatus 1110 provides an application service to the accessed user.

More specifically, the service apparatus 1110 provides a single application service or a plurality of application services to the accessed user through the Web.

The application service refers to various services provided on the corresponding Web according to the driving of an installed application, and may correspond to various types of services, for example, a personal blog service, a messenger service, a product purchase service, a personal homepage service, a video reproduction service, a music reproduction service, a location based advertisement service, a path finding service, and an SNS service.

The object registering unit 1120 transmits the service information corresponding to the application service to make a request for registering the service information as the object.

More specifically, in providing each application service to the accessed user, the object registering unit 1120 extracts service information according to the user's designation and transmits the extracted service information to the object management apparatus 1200, so as to register the service information as the object for sharing between the service applications.

The service information may correspond to one or more driving functions supported by the installed application to provide each application service, data generated according to the driving of the installed application to provide each application service, and a content reproduced or shown when each application service is provided.

At this time, in registering the object of the service information, the object registering unit 1120 additionally transmits type information for distinguishing a type of service information, for example, an application function type, a data type, and a content type, an execution environment of the corresponding application service from which the service information is extracted, for example, a driving OS, service identification information for identifying a capability of the service apparatus executing the application service, and sharing setting information for designating a target to share each object, for example, a service provider, an individual, a national organization, and development company, so as to register each object such that the additionally received matters are mapped into the objects on the object management apparatus 1200.

For example, in providing the personal homepage service to the accessed user in connection with one or more driving functions supported by the aforementioned application, the object registering unit 1120 extracts the corresponding function as the service information and transmits the extracted function to the object management apparatus 1200 according to the user's designation, so as to register the image editing function as the object.

Further, in providing the video reproduction service to the accessed user in connection with the data generated according to the driving of the aforementioned application, the object registering unit 1120 extracts the corresponding data as the service information and transmits the extracted data to the object management apparatus 1200 according to the user's designation for the viewed video list, so as to register the viewed video list as the object.

In addition, in providing the advertisement service to the accessed user in connection with the content reproduced or exposed when the aforementioned service is provided, the object registering unit 1120 extracts the corresponding content as the service information and transmits the extracted content to the object management apparatus 1200 according to the user's designation for the advertisement for each situation provided based on a particular area, so as to register the image editing function as the object.

The object executer 1130 loads and executes the registered object when the application service is provided.

More specifically, when a request for sharing the object is made by the user when a new application service is provided to the accessed user, the object executer 1130 receives a search list of the registered object from the object management apparatus 1200 and loads one or a plurality of objects based on the received search list, so as to execute the loaded object on the currently provided application service.

At this time, as the object executer 1130 transmits type information on the object to be shared to the object management apparatus 1200, the object executer 1130 may be implemented to receive a search list of the object selected based on the type information on the transmitted object from the object management apparatus 1200.

Further, as the object executer 1130 transmits the type information and the service identification information for identifying an execution environment of a currently provided particular application service when making the request for sharing the object, the object executer 1300 may be implemented to receive the search list for the object selected to simultaneously satisfy the type information on the transmitted object and the execution environment of the particular application service or the search list for the object of which a data conversion is performed to satisfy the execution environment from the object management apparatus 1200.

In addition, when making the request for sharing the object, the object executer 1130 may be implemented to receive the search list for the object that satisfies the type information on the transmitted object and the execution environment of the particular application service and satisfies sharing setting information in which a counterpart with which each object can be shared is set at the same time from the object management apparatus 1200.

For example, when providing the personal blog service to the accessed user, the object executer 1130 loads the corresponding object from the object management apparatus 1200 according to a user's request for an image editing function registered as the object, and thus allows the image editing function to be additionally shown on the personal blog service and executed on the personal blog service.

Further, when providing the messenger service to the accessed user, the object executer 1130 loads the corresponding object from the object management apparatus 1200 according to a user's request for sharing the viewed video list registered as the object, and thus allows the viewed video list to be transmitted to a conversation counterpart while providing the messenger service.

In addition, when providing the path finding service to the accessed user, the object executer 1130 loads the corresponding object from the object management apparatus 1200 according to a user's request for an advertisement for each situation registered as the object, and thus allows the loaded advertisement for each situation to be shown if the user is located in a corresponding area while providing the path finding service.

Furthermore, when the object executer 1130 receives a request for a plurality of SNS posting functions registered as the objects from the accessed user, the object executer 1130 loads the plurality of objects from the object management apparatus 1200, and thus allows the plurality of SNS posting functions for each production company to be simultaneously shown on a particular site.

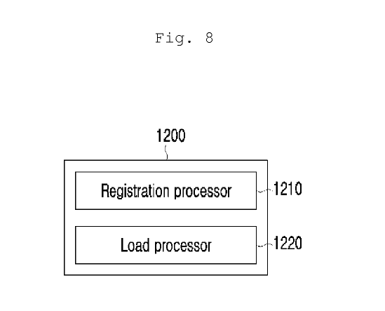

Hereinafter, a more detailed configuration of the object management apparatus 1200 according to an embodiment of the present disclosure will be described with reference to FIG. 8.

As illustrated in FIG. 8, the object management apparatus 1200 includes a registration processor 1210 that registers the service information received from the service apparatus 1100 as the object, and a load processor 1220 that extracts and provides the registered object when receiving an object sharing request from the service apparatus 1100.

The registration processor 1210 receives service information designated to correspond to the application service from the service apparatus 1100 and registers the received service information as the object for each user.

More specifically, the registration processor 1210 receives service information extracted according to the user's designation from the service apparatus 1100 which provides the application service to the accessed user and registers the received service information as the object for each user, so as to allow the registered object to be shared between the application services.

The service information registered as the object may correspond to one or more driving functions supported by the installed application to provide each application service, data generated according to the driving of the installed application to provide each application service, and a content reproduced or shown when each application service is provided.

At this time, in registering the object of the service information, the registration processor 1210 additionally receives type information for distinguishing a type of service information, for example, an application function type, a data type, and a content type, an execution environment of the corresponding application service from which the service information is extracted, for example, a driving OS, service identification information for identifying a capability of the service apparatus executing the application service, and sharing setting information for designating a target to share each object, for example, a service provider, an individual, a national organization, and development company from the service apparatus 1100, so as to register each object such that the additionally received matters are mapped to the objects.

For example, when the service apparatus 1100 provides a personal homepage service to the accessed user in connection with one or more driving functions supported by the aforementioned application, the registration processor 1210 receives an image editing function for registering and editing a picture from the service apparatus as service information and registers the received image editing function as the object.

Further, when the service apparatus 1100 provides a video reproduction service to the accessed user in connection with data generated according to the driving of the aforementioned application, the registration processor 1210 receives a viewed video list from the service apparatus 1100 as service information and registers the received viewed video list as the object.

In addition, when the service apparatus 1100 provides an advertisement service to the accessed user in connection with a content reproduced or shown while providing the aforementioned application, the registration processor 1210 receives an advertisement for each situation provided in connection with a particular area from the service apparatus 1100 as service information and registers the received advertisement as the object.

When receiving an object sharing request from the service apparatus 1100, the load processor 1220 extracts and provides the registered object.

More specifically, when the object sharing request is made by the service apparatus 1100 that provides a new application service to the accessed user, the load processor 1220 provides the search list of the registered object to the service apparatus 1100.

At this time, when the load processor 1220 additionally receives type information on the object to be shared in receiving the object sharing request from the service apparatus 1100, the load processor 1220 may select an object that matches the type information on the received object and provide a search list of the selected object to the service apparatus 1100.

Further, when the load processor 1220 additionally receives service identification information for identifying an execution environment of a particular application service currently provided by the service apparatus 1100 together with the type information on the object to be shared in receiving the object sharing request from the service apparatus 1100, the load processor 1200 may provide a search list of the object selected to simultaneously satisfy the type information and the execution environment of the particular application service or object of which a data conversion is performed to satisfy the execution environment.

In addition, when the load processor 1220 receives the object sharing request from the service apparatus 1100, the load processor 1220 selects the object that satisfies the execution information and the execution environment of the particular application and additionally satisfies sharing setting information in which a counterpart with which each object can be shared is set and provides a search list of the selected object by identifying the service apparatus 1100 transmitting the object sharing request.

Furthermore, the load processor 1220 extracts and provides the loaded object.

More specifically, when one or a plurality of objects are loaded based on the provided search list, the load processor 1220 extracts and provides the corresponding object, so as to allow the object provided on the application service currently provided by the service apparatus 1100 to be additionally executed.

For example, when an image editing function registered as the object is loaded by the service apparatus 1100 which provides a personal blog service to the accessed user, the load processor 1220 extracts and provides the corresponding object to the service apparatus 1100, so as to allow the image editing function to be additionally shown on the personal blog service serviced through the service apparatus 1100.

Further, when a viewed video list registered as the object is loaded by the service apparatus 1100 which provides a messenger service to the accessed user, the load processor 1220 extracts and provides the corresponding object to the service apparatus 1100, so as to allow the viewed video list to be transmitted to a counterpart who has a conversation in providing the messenger service.

Furthermore, when an advertisement for each situation registered as the object is loaded by the service apparatus 1100 which provides a path finding service to the accessed user, the load processor 1220 extracts and provides the corresponding object to the service apparatus 1100, so as to allow the advertisement for each situation to be shown if the user is located in a corresponding area while providing the path finding service.

In addition, when a plurality of SNS posting functions registered as the objects are loaded by the service apparatus 1100, the load processor 1220 extracts and provides the plurality of registered objects, so as to allow the plurality of SNS posting functions for each production company to be simultaneously shown on a particular site serviced through the service apparatus 1100.

As described above, according to the object sharing system of the present disclosure, as an object sharing function is mutually supported between application services by registering a component of the application service as a sharable object according to user's designation with respect to each of various application services provided on the web, searching for the registered object, and loading the found object between the application services so as to mutually use the object, various demands of users can be satisfied and a new application service in a web environment also can be created.

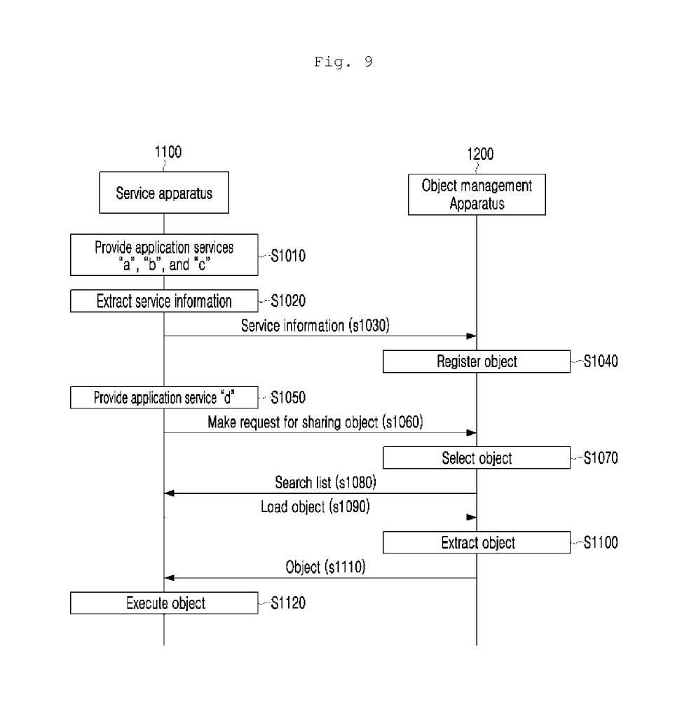

Hereinafter, an object management method according to an embodiment of the present disclosure will be described with reference to FIGS. 9 and 6. The same configurations as those illustrated in FIGS. 6 to 8 are assigned the same corresponding reference numerals for the convenience of description.

First, an operation method of the object management system according to an embodiment of the present disclosure will be described with reference to FIG. 9.

The service apparatus 1100 provides an application service to the accessed user in S1010.

Preferably, the service apparatus 1100 provides a single application service or a plurality of application services to the accessed user through the Web.

The application service refers to various services provided on the corresponding Web according to the driving of an installed application, and may correspond to various types of services, for example, a personal blog service, a messenger service, a product purchase service, a personal homepage service, a video reproduction service, a music reproduction service, a location based advertisement service, a path finding service, and an SNS service.

Then, the service apparatus 1100 extracts the service information corresponding to the application service in S1020.

Preferably, when the service apparatus 1100 provides each application service to the accessed user, the service apparatus extracts service information according to the user's designation.

The service information may correspond to one or more driving functions supported by the installed application to provide each application service, data generated according to the driving of the installed application to provide each application service, and a content reproduced or shown when each application service is provided.

Then, the service apparatus 1100 transmits the extracted service information and makes a request for registering the service information as the object in S1030.

Preferably, when the service apparatus 1100 provides the application service, the service apparatus 1100 transmits the extracted service information according to the user's designation to the object management apparatus 1200, so as to register the service information as the object for sharing between the service applications.

Subsequently, the object management apparatus 1200 receives service information designated to correspond to the application service from the service apparatus 1100 and registers the received service information as the object for each user in S1040.

More specifically, the object management apparatus 1200 receives service information extracted according to the user's designation from the service apparatus 1100 which provides the application service to the accessed user and registers the received service information as the object for each user, so as to allow the registered object to be shared between the application services.

At this time, in registering the object of the service information, the object management apparatus 1200 additionally receives type information for distinguishing a type of service information, for example, an application function type, a data type, and a content type, an execution environment of the corresponding application service from which the service information is extracted, for example, a driving OS, service identification information for identifying a capability of the service apparatus executing the application service, and sharing setting information for designating a target to share each object, for example, a service provider, an individual, a national organization, and development company from the service apparatus 1100, so as to register each object such that the additionally received matters are mapped to the objects.

For example, when the service apparatus 1100 provides a personal homepage service to the accessed user in connection with one or more driving functions supported by the aforementioned application, the object management apparatus 1200 receives an image editing function for registering and editing a picture from the service apparatus as service information and registers the received image editing function as the object.

Further, when the service apparatus 1100 provides a video reproduction service to the accessed user in connection with data generated according to the driving of the aforementioned application, the object management apparatus 1200 receives a viewed video list from the service apparatus 1100 as service information and registers the received viewed video list as the object.

In addition, when the service apparatus 1100 provides an advertisement service to the accessed user in connection with a content reproduced or shown while providing the aforementioned application, the object management apparatus 1200 receives an advertisement for each situation provided in connection with a particular area from the service apparatus 1100 as service information and registers the received advertisement as the object.

Furthermore, when the service apparatus 1100 provides the application service, the service apparatus 1100 transmits a sharing request for the registered object in S1050-S1060.

Preferably, when the service apparatus 1100 provides a new application service to the accessed user, if the object sharing request is made by the user, the service apparatus 1100 transmits the sharing request for the registered object to the object management apparatus 1200.

Then, the object management apparatus 1200 provides a search list of the registered object in S1070 to S1080.

Preferably, when the object management apparatus 1200 receives the object sharing request from the service apparatus 1100 that provides the new application service to the accessed user, the object management apparatus 1200 identifies the user accessing the service apparatus 1100 and provides the search list of the registered object which is mapped into the identified user to the service apparatus 1100.

At this time, when the object management apparatus 1200 additionally receives type information on the object to be shared in receiving the object sharing request from the service apparatus 1100, the object management apparatus 1200 may select an object that matches the type information on the received object and provide a search list of the selected object to the service apparatus 1100.

Further, when the object management apparatus 1200 additionally receives service identification information for identifying an execution environment of a particular application service currently provided by the service apparatus 1100 together with the type information on the object to be shared in receiving the object sharing request from the service apparatus 1100, the object management apparatus 1200 may provide a search list of the object selected to simultaneously satisfy the type information and the execution environment of the particular application service or object of which a data conversion is performed to satisfy the execution environment.

In addition, when the object management apparatus 1200 receives the object sharing request from the service apparatus 1100, the object management apparatus 1200 selects the object that satisfies the execution information and the execution environment of the particular application and additionally satisfies sharing setting information in which a counterpart with which each object can be shared is set and provides a search list of the selected object by identifying the service apparatus 1100 transmitting the object sharing request.

Thereafter, the object management apparatus 1200 extracts and provides the loaded object in S1090 to S1110.

Preferably, when one or a plurality of objects are loaded based on the provided search list, the object management apparatus 1200 extracts and provides the corresponding object, so as to allow the object provided on the application service currently provided by the service apparatus 1100 to be additionally executed.

For example, when an image editing function registered as the object is loaded by the service apparatus 1100 which provides a personal blog service to the accessed user, the object management apparatus 1200 extracts and provides the corresponding object to the service apparatus 1100, so as to allow the image editing function to be additionally shown on the personal blog service serviced through the service apparatus 1100.

Further, when a viewed video list registered as the object is loaded by the service apparatus 1100 which provides a messenger service to the accessed user, the object management apparatus 1200 extracts and provides the corresponding object to the service apparatus 1100, so as to allow the viewed video list to be transmitted to a conversation counterpart while providing the messenger service.

Furthermore, when an advertisement for each situation registered as the object is loaded by the service apparatus 1100 which provides a path finding service to the accessed user, the object management apparatus 1200 extracts and provides the corresponding object to the service apparatus 1100, so as to allow the advertisement for each situation to be shown if the user is located in a corresponding area while providing the path finding service.

In addition, when a plurality of SNS posting functions registered as the objects are loaded by the service apparatus 1100, the object management apparatus 1200 extracts and provides the plurality of registered objects, so as to allow the plurality of SNS posting functions for each production company to be simultaneously shown on a particular site serviced through the service apparatus 1100.

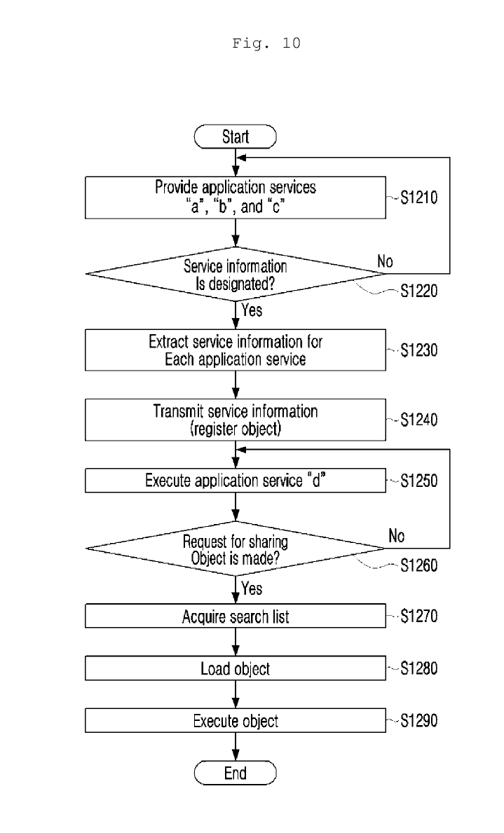

Hereinafter, the operation method of the object management apparatus 1100 according to an embodiment of the present disclosure will be described with reference to FIG. 10.

First, an application service is provided to the accessed user in S1210

Preferably, the service provider 1110 provides a single application service or a plurality of application services to the accessed user through the Web. The application service refers to various services provided on the corresponding Web according to the driving of an installed application, and may correspond to various types of services, for example, a personal blog service, a messenger service, a product purchase service, a personal homepage service, a video reproduction service, a music reproduction service, a location based advertisement service, a path finding service, and an SNS service.

Then, service information corresponding to the application service is extracted in S1220 to S1230.

Preferably, when the object registering unit 1120 provides each application service to the accessed user, the object registering unit 1120 extracts service information according to the user's designation.

The service information may correspond to one or more driving functions supported by the installed application to provide each application service, data generated according to the driving of the installed application to provide each application service, and a content reproduced or exposed when each application service is provided.

Then, the extracted service information is registered as the object in S1240.

Preferably, the object registering unit 1120 transmits the extracted service information to the object management apparatus 1200, so as to register the service information as the object for sharing between the service applications.

At this time, in registering the object of the service information, the object registering unit 1120 additionally transmits type information for distinguishing a type of service information, for example, an application function type, a data type, and a content type, an execution environment of the corresponding application service from which the service information is extracted, for example, a driving OS, service identification information for identifying a capability of the service apparatus executing the application service, and sharing setting information for designating a target to share each object, for example, a service provider, an individual, a national organization, and development company, so as to register each object such that the additionally received matters are mapped into the objects on the object management apparatus 1200.

For example, in providing the personal homepage service to the accessed user in connection with one or more driving functions supported by the aforementioned application, the object registering unit 1120 extracts the corresponding function as the service information and transmits the extracted function to the object management apparatus 1200 according to the user's designation, so as to register the image editing function as the object.

Further, in providing the video reproduction service to the accessed user in connection with the data generated according to the driving of the aforementioned application, the object registering unit 1120 extracts the corresponding data as the service information and transmits the extracted data to the object management apparatus 1200 according to the user's designation for the viewed video list, so as to register the viewed video list as the object.

In addition, in providing the advertisement service to the accessed user in connection with the content reproduced or exposed when the aforementioned service is provided, the object registering unit 1120 extracts the corresponding content as the service information and transmits the extracted content to the object management apparatus 1200 according to the user's designation for the advertisement for each situation provided based on a particular area, so as to register the image editing function as the object.

Furthermore, when the application service is provided, a search list is received according to an object sharing request by the user in S1250 to S1270.

Preferably, when the object executer 1130 provides a new application service to the accessed user, if the object sharing request is made by the user, the object executer 1130 receives the search list of the registered object to the object management apparatus 1200.

At this time, as the object executer 1130 transmits type information on the object to be shared to the object management apparatus 1200, the object executer 1130 may be implemented to receive a search list of the object selected based on the type information on the transmitted object from the object management apparatus 1200.

Further, as the object executer 1130 transmits the type information and the service identification information for identifying an execution environment of a currently provided particular application service when making the request for sharing the object, the object executer 1300 may be implemented to receive the search list for the object selected to simultaneously satisfy the type information on the transmitted object and the execution environment of the particular application service or the search list for the object of which a data conversion is performed to satisfy the execution environment from the object management apparatus 1200.

In addition, when making the request for sharing the object, the object executer 1130 may be implemented to receive the search list for the object that satisfies the type information on the transmitted object and the execution environment of the particular application service and satisfies sharing setting information in which a counterpart with which each object can be shared is set at the same time from the object management apparatus 1200.

Thereafter, the object is extracted and executed based on the received search list in S1280 to S1290.

Preferably, the object executer 1130 loads one object or a plurality of objects based on the received search list, so as to allow the loaded object to be executed on the currently provided application.

For example, when providing the personal blog service to the accessed user, the object executer 1130 loads the corresponding object from the object management apparatus 1200 according to a user's request for an image editing function registered as the object, and thus allows the image editing function to be additionally shown on the personal blog service and executed on the personal blog service.

Further, when providing the messenger service to the accessed user, the object executer 1130 loads the corresponding object from the object management apparatus 1200 according to a user's request for sharing the viewed video list registered as the object, and thus allows the viewed video list to be transmitted to a conversation counterpart while providing the messenger service.

In addition, when providing the path finding service to the accessed user, the object executer 1130 loads the corresponding object from the object management apparatus 1200 according to a user's request for an advertisement for each situation registered as the object, and thus allows the loaded advertisement for each situation to be shown if the user is located in a corresponding area while providing the path finding service.

Furthermore, when the object executer 1130 receives a request for a plurality of SNS posting functions registered as the objects from the accessed user, the object executer 1130 loads the plurality of objects from the object management apparatus 1200, and thus allows the plurality of SNS posting functions for each production company to be simultaneously shown on a particular site.

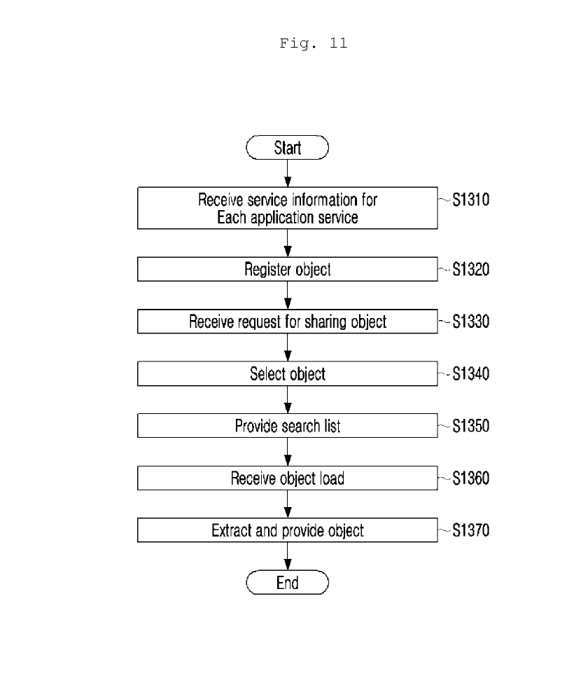

Hereinafter, the operation method of the object management apparatus 1200 according to an embodiment of the present disclosure will be described with reference to FIG. 11.

First, the service information designated to correspond to the application service is received from the service apparatus 1100 and registered as the object for each user in S1310 to S1320.

Preferably, the registration processor 1210 receives service information extracted according to the user's designation from the service apparatus 1100 that provides the application service to the accessed user and registers the received service information as the object for each user, so as to allow the registered object to be shared between the application services.

The service information registered as the object may correspond to one or more driving functions supported by the installed application to provide each application service, data generated according to the driving of the installed application to provide each application service, and a content reproduced or shown when each application service is provided.

At this time, in registering the object of the service information, the registration processor 1210 additionally receives type information for distinguishing a type of service information, for example, an application function type, a data type, and a content type, an execution environment of the corresponding application service from which the service information is extracted, for example, a driving OS, service identification information for identifying a capability of the service apparatus executing the application service, and sharing setting information for designating a target to share each object, for example, a service provider, an individual, a national organization, and development company from the service apparatus 1100, so as to register each object such that the additionally received matters are mapped to the objects.

For example, when the service apparatus 1100 provides a personal homepage service to the accessed user in connection with one or more driving functions supported by the aforementioned application, the registration processor 1210 receives an image editing function for registering and editing a picture from the service apparatus as service information and registers the received image editing function as the object.

Further, when the service apparatus 1100 provides a video reproduction service to the accessed user in connection with data generated according to the driving of the aforementioned application, the registration processor 1210 receives a viewed video list from the service apparatus 1100 as service information and registers the received viewed video list as the object.

In addition, when the service apparatus 1100 provides an advertisement service to the accessed user in connection with a content reproduced or exposed in providing the aforementioned application, the registration processor 1210 receives an advertisement for each situation provided in connection with a particular area from the service apparatus 1100 as service information and registers the received advertisement as the object.

Then, when an object sharing request is received from the service apparatus 1100, a search list is provided in S1330 to S1350.

Preferably, when the load processor 1220 receives the object sharing request from the service apparatus 1100 that provides the new application service to the accessed user, the load processor 1200 identifies the user accessing the service apparatus 1100 and provides the search list of the registered object which is mapped into the identified user to the service apparatus 1100.

At this time, when the load processor 1220 additionally receives type information on the object to be shared in receiving the object sharing request from the service apparatus 1100, the load processor 1220 may select an object that matches the type information on the received object and provide a search list of the selected object to the service apparatus 1100.

Further, when the load processor 1220 additionally receives service identification information for identifying an execution environment of a particular application service currently provided by the service apparatus 1100 together with the type information on the object to be shared in receiving the object sharing request from the service apparatus 1100, the load processor 1200 may provide a search list of the object selected to simultaneously satisfy the type information and the execution environment of the particular application service or object of which a data conversion is performed to satisfy the execution environment.

In addition, when the load processor 1220 receives the object sharing request from the service apparatus 1100, the load processor 1220 selects the object that satisfies the execution information and the execution environment of the particular application and additionally satisfies sharing setting information in which a counterpart with which each object can be shared is set and provides a search list of the selected object by identifying the service apparatus 1100 transmitting the object sharing request.

Thereafter, the corresponding object loaded from the service apparatus 1100 is extracted and provided in S1360 to S1370.

Preferably, when one or a plurality of objects are loaded based on the provided search list, the load processor 1220 extracts and provides the corresponding object, so as to allow the object provided on the application service currently provided by the service apparatus 1100 to be additionally executed.

For example, when an image editing function registered as the object is loaded by the service apparatus 1100 which provides a personal blog service to the accessed user, the load processor 1220 extracts and provides the corresponding object to the service apparatus 1100, so as to allow the image editing function to be additionally shown on the personal blog service serviced through the service apparatus 1100.

Further, when a viewed video list registered as the object is loaded by the service apparatus 1100 which provides a messenger service to the accessed user, the load processor 1220 extracts and provides the corresponding object to the service apparatus 1100, so as to allow the viewed video list to be transmitted to a conversation counterpart while providing the messenger service.

Furthermore, when an advertisement for each situation registered as the object is loaded by the service apparatus 1100 which provides a path finding service to the accessed user, the load processor 1220 extracts and provides the corresponding object to the service apparatus 1100, so as to allow the advertisement for each situation to be shown if the user is located in a corresponding area while providing the path finding service.

In addition, when a plurality of SNS posting functions registered as the objects are loaded by the service apparatus 1100, the load processor 1220 extracts and provides the plurality of registered objects, so as to allow the plurality of SNS posting functions for each production company to be simultaneously shown on a particular site serviced through the service apparatus 1100.

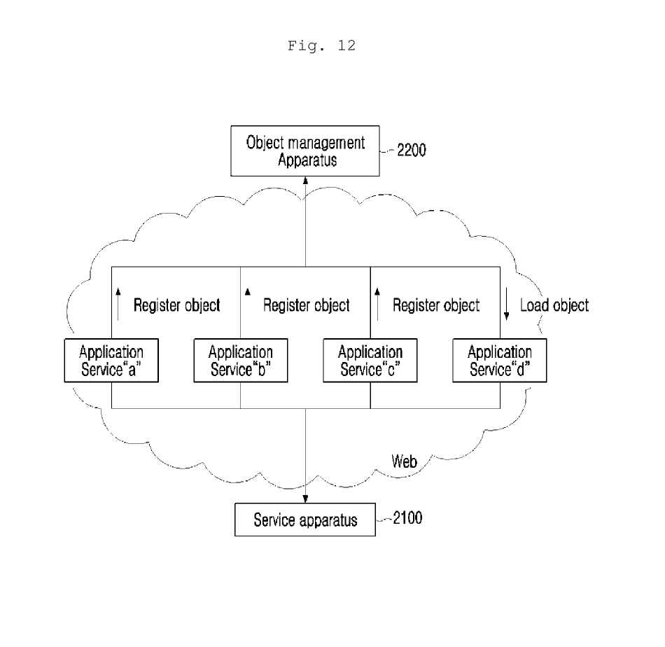

FIG. 12 illustrates a schematic configuration of a personal object management system according to an embodiment of the present disclosure.

As illustrated in FIG. 12, the system includes a service apparatus 2100 that acquires content information selected for each application service, transmits the acquired content information to make a request for registering the content information as an object, and loads and executes the registered object while accessing a particular application service, and an object management apparatus 2200 that identifies the content information received from the service apparatus 2100 as an object to register the object, extracts the corresponding object according to the load of the registered object, and provides the extracted object.

The service apparatus 2100 refers to a terminal apparatus for accessing various application services through the Web or WAP or by executing an application installed therein, and may correspond to a Personal Computer (PC), a smart phone, and an Internet Protocol TeleVision (IPTV).

The content information acquired from the application service may correspond to one or more driving functions supported by the application installed to provide each application service, data generated according to the driving of the application installed to provide each application service, and a content reproduced or exposed when each application service is provided.

The service apparatus 2100 accesses an application service according to a user's request.

More specifically, the service apparatus 2100 accesses application services serviced through the Web or WAP according to a user's request or serviced through the driving of the application installed therein, for example, various types of services such as a personal blog service, a messenger service, a product purchase service, a personal homepage service, a video reproduction service, a music reproduction service, a location based advertisement service, a path finding service, and a Social Networking Service (SNS).

The service apparatus 2100 provides a user interface and acquires content information when accessing the application service.

More specifically, when accessing the application service according to a user's request, the service apparatus 2100 provides a user interface on a service screen to acquire content information corresponding to the corresponding application service, and acquires content information selected by the user from the service screen through the provided user interface.

For example, when accessing the product purchase service, the service apparatus 2100 provides a user interface in a tool bar type on the service screen and receives content information on the service screen by a user's selection on the service screen, that is, a drag and drop action, for example, information on a product purchased by the user or information on a product of interest transmitted through the provided user interface, so as to acquire content information corresponding to the corresponding application service.

When the application service is executed through the driving of the application installed in the service apparatus 2100, the user interface may apply a different type such as selecting a button, not the drag and drop action.

Meanwhile, when the service apparatus 2100 simultaneously accesses a plurality of application services (for example, a first application service and a second application service), the service apparatus 2100 provides a first user interface on a corresponding service screen according to the access to the first application service and provides a second user interface on a corresponding service screen according to the access to the second application service.

Based on the above description, the service apparatus 2100 acquires content information selected by the user from the first application service and content information selected by the user from the second application service through the first user interface, and also acquires content information selected by the user from the second application service and content information selected by the user from the first application service through the second user interface.

For example, when the service apparatus 2100 accesses a product purchase service and a personal homepage service according to a user's request, the service apparatus 2100 provides a user interface in a tool bar form on a service screen of each of the production purchase service and the personal homepage service.

At this time, when content information selected from the product purchase service by the user's selection made on each service screen, that is, the drag and drop action is transmitted to a user interface corresponding to the personal homepage service, the service apparatus 2100 may acquire content information selected from the product purchase service in accordance with the personal homepage service. In contrast, when content information selected from the personal homepage service is transmitted to a user interface corresponding to the product purchase service, the service apparatus 2100 may acquire content information selected from the personal homepage service in accordance with the product purchase service.

The service apparatus 2100 transmits the acquired content information to the object management apparatus 2200 and registers the content information as an object.

More specifically, by transmitting the content information acquired for each application service to the object management apparatus 2200, the service apparatus 2100 allows the object management apparatus 2200 to register the received content information as the object for each application service.

Further, by transmitting user identification information (for example, ID) for each application service when transmitting the content information, the service apparatus 2100 allows the object management apparatus 220 to combine user identification information for each application service into one representative identification information, so that content information for each application service transmitted in accordance with the same user may be combined into the representative identification information and the representative identification information may be managed.

When accessing a particular application service, the service apparatus 2100 loads and executes a registered object.

More specifically, when receiving an object load request from the user while accessing a particular application service, the service apparatus 2100 receives an inquiry service of the object registered for each application from the object management apparatus 2200 or loads one or a plurality of objects, so as to allow the loaded objects to be simultaneously executed on the currently accessed application service.

At this time, by transmitting the user identification information (for example, ID) to the object management apparatus 2200 when the object is loaded, the service apparatus 2100 acquires representative identification information designated to correspond to the user identification information and allows the object which is mapped into the identified representative identification information, and registered and managed for each user to be inquired.

Further, by transmitting content format information required for each service apparatus, for example, a screen size, a resolution, and a driving OS to the object management apparatus 2200 when the object is loaded, the service apparatus 2100 allows the object management apparatus 2200 to change a format of content information registered as the object in accordance with a content format required for the service apparatus 2100 that loads the object based on the content format information and to provide the changed type of content information.

For example, when providing a personal blog service to the accessed user, the service apparatus 2100 loads the corresponding object from the object management apparatus 2200 according to a user's request for an image editing function registered as the object, and thus allows the image editing function to be additionally shown on the personal blog service and executed on the personal blog service.

Further, when providing a messenger service to the accessed user, the service apparatus 2100 loads the corresponding object from the object management apparatus 2200 according to a user's request for a viewed video list registered as the object, and thus allows the viewed video list to be transmitted to a conversation counterpart while providing the messenger service.

In addition, when providing a path finding service to the accessed user, the service apparatus 2100 loads the corresponding object from the object management apparatus 2200 according to a user's request for an advertisement for each situation registered as the object, and thus allows the loaded advertisement for each situation to be shown if the user is located in a corresponding area while providing the path finding service.

Furthermore, when the accessed user makes a request for a plurality of SNS posting functions registered as the objects, the service apparatus 2100 loads the plurality of objects from the object management apparatus 2200, and thus allows the plurality of SNS posting functions for each production company to be simultaneously shown on a particular site.

The object management apparatus 2200 receives content information selected when the service apparatus 2100 accesses the application service.

More specifically, the object management apparatus 2200 receives the content information for each application acquired through the user interface on the application service screen from the service apparatus 2100.

For example, the object management apparatus 2200 receives content information acquired through the user interface in the tool bar form on the service screen from the service apparatus 2100 that accesses the product purchase service according to the user's request, for example, purchased product information or information on a product of interest.

The object management apparatus 2200 registers the content information received from the service apparatus 2100 as the object for each application service.

More specifically, the object management apparatus 2200 combines different user identification information (for example, ID) for each of a plurality of service applications into one representative identification information, manages the representative identification information, and identifies the representative identification information designated in accordance with the user identification information transmitted from the service apparatus 2100, so as to map the content information received from the service apparatus 2100 into the identified representative identification information and register the representative identification information as the object for each user.

Further, when the object management apparatus 2200 receives the content information from the service apparatus 2100, the object management apparatus 2200 identifies whether a resource (for example, execution file) for executing the corresponding content information is included in the content information. When the resource is not included, the object management apparatus 2200 acquires a resource for executing the received content information from a separate apparatus (for example, server) that provides the application service from which the content information is extracted, and registers the resource as the object.

The object management apparatus 2200 extracts and provides the corresponding object according to the load of the registered object.

More specifically, when receiving an object load request from the service apparatus 2100 which accesses a particular application service, the object management apparatus 2200 provides an inquiry service of the registered object in accordance with the corresponding user or extracts and then provides one or a plurality of objects, so as to allow the provided objects to be simultaneously executed on the currently accessed application service.

At this time, by receiving the user identification information (for example, ID) from the service apparatus 2100, the object management apparatus 2200 identifies the representative identification information designated to correspond to the user identification information and inquires about the object which is mapped into the identified representative identification information, and registered and managed for each user.

Further, by receiving content format information required for the accessed apparatus, for example, a screen size, a resolution, and a driving OS from the service apparatus 2100, the object management apparatus 2200 changes a format of content information registered as the object based on the content format information to support a content format required by the service apparatus 2100.

For example, when an image editing function registered as the object is loaded by the service apparatus 2100 which provides a personal blog service to the accessed user, the object management apparatus 2200 extracts and provides the corresponding object to the service apparatus 2100, so as to allow the image editing function to be additionally shown on the personal blog service serviced through the service apparatus 2100.

Further, when a viewed video list registered as the object is loaded by the service apparatus 2100 that provides a messenger service to the accessed user, the object management apparatus 2200 extracts and provides the corresponding object to the service apparatus 2100, so as to allow the viewed video list to be transmitted to a conversation counterpart while providing the messenger service.

Furthermore, when an advertisement for each situation registered as the object is loaded by the service apparatus 2100 which provides a path finding service to the accessed user, the object management apparatus 2200 extracts and provides the corresponding object to the service apparatus 2100, so as to allow the advertisement for each situation to be shown if the user is located in a corresponding area while providing the path finding service.

In addition, when a plurality of SNS posting functions registered as the objects are loaded by the service apparatus 2100, the object management apparatus 2200 extracts and provides the plurality of registered objects, so as to allow the plurality of SNS posting functions for each production company to be simultaneously shown on a particular site serviced through the service apparatus 2100.

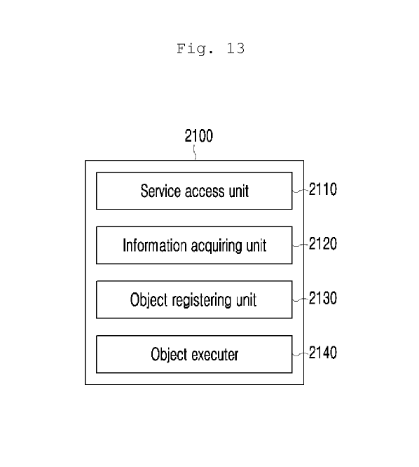

Hereinafter, a more detailed configuration of the service apparatus 2100 according to an embodiment of the present disclosure will be described with reference to FIG. 13.

As illustrated in FIG. 13, the service apparatus 2100 includes a service accessing unit 2110 that accesses an application service according to a user's request, an information acquiring unit 2120 that acquires content information through provision of a user interface, an object registering unit 2130 that transmits the acquired content information to make a request for registering the content information as an object, and an object executer that loads and executes the registered object.

The service accessing unit 2110 accesses an application service according to a user's request.

More specifically, the service accessing unit 2110 accesses application services serviced through the Web or WAP according to a user's request or serviced through the driving of the application installed therein, for example, various types of services such as a personal blog service, a messenger service, a product purchase service, a personal homepage service, a video reproduction service, a music reproduction service, a location based advertisement service, a path finding service, and a Social Networking Service (SNS).

The information acquiring unit 2120 provides a user interface and acquires content information when accessing the application service.

More specifically, when the service accessing unit 2110 accesses the application service, the information acquiring unit 2120 provides a user interface on a service screen to acquire content information corresponding to the corresponding application service, and acquires content information selected by the user from the service screen through the provided user interface.

For example, when accessing the product purchase service, the service apparatus 2100 provides a user interface in a tool bar type on the service screen and receives content information on the service screen by a user's selection on the service screen, that is, a drag and drop action, for example, information on a product purchased by the user or information on a product of interest transmitted through the provided user interface, so as to acquire content information corresponding to the corresponding application service.

When the application service is executed through the driving of the application installed in the service apparatus 2100, the user interface may apply a different type such as selecting a button, not the drag and drop action.

Meanwhile, when the service apparatus 2100 simultaneously accesses a plurality of application services (for example, a first application service and a second application service), the information acquiring unit 2120 provides a first user interface on a corresponding service screen according to the access to the first application service and provides a second user interface on a corresponding service screen according to the access to the second application service.

Based on the above description, the information acquiring unit 2120 acquires content information selected by the user from the first application service and content information selected by the user from the second application service through the first user interface, and also acquires content information selected by the user from the second application service and content information selected by the user from the first application service through the second user interface.

For example, when the service apparatus 2100 accesses a product purchase service and a personal homepage service according to a user's request, the information acquiring unit 2120 provides a user interface in a tool bar form on a service screen of each of the production purchase service and the personal homepage service.

At this time, when content information selected from the product purchase service by the user's selection made on each service screen, that is, the drag and drop action is transmitted to a user interface corresponding to the personal homepage service, the information acquiring unit 2120 may acquire content information selected from the product purchase service in accordance with the personal homepage service. In contrast, when content information selected from the personal homepage service is transmitted to a user interface corresponding to the product purchase service, the information acquiring unit 2120 may acquire content information selected from the personal homepage service in accordance with the product purchase service.

The object registering unit 2130 transmits the acquired content information to the object management apparatus 2200 and registers the content information as an object.

More specifically, by transmitting the content information acquired for each application service to the object management apparatus 2200, the object registering unit 2130 allows the object management apparatus 2200 to register the received content information as the object for each application service.

Further, by transmitting user identification information (for example, ID) for each application service when transmitting the content information, the object registering unit 2130 allows the object management apparatus 220 to combine user identification information for each application service into one representative identification information, so that content information for each application service transmitted in accordance with the same user may be combined into the representative identification information and the representative identification information may be managed.

When the service apparatus 2100 accesses a particular application service, the object executer 2140 loads and executes a registered object.

More specifically, when the service apparatus 2100 receives an object load request from the user while accessing a particular application service, the object executer 2140 receives an inquiry service of the object registered for each application from the object management apparatus 2200 or loads one or a plurality of objects, so as to allow the loaded objects to be simultaneously executed on the currently accessed application service.

At this time, by transmitting the user identification information (for example, ID) to the object management apparatus 2200 when the object is loaded, the object executer 2140 acquires representative identification information designated to correspond to the user identification information and allows the object which is mapped into the identified representative identification information, and registered and managed for each user to be inquired.

Further, by transmitting content format information required for each service apparatus, for example, a screen size, a resolution, and a driving OS to the object management apparatus 2200 when the object is loaded, the object executer 2140 allows the object management apparatus 2200 to change a format of content information registered as the object in accordance with a content format required for the service apparatus 2100 that loads the object based on the content format information and to provide the changed type of content information.

For example, when a personal blog service is provided to the accessed user, the object executer 2140 loads the corresponding object from the object management apparatus 2200 according to a user's request for an image editing function registered as the object, and thus allows the image editing function to be additionally shown on the personal blog service and executed on the personal blog service.

Further, when a messenger service is provided to the accessed user, the object executer 2140 loads the corresponding object from the object management apparatus 2200 according to a user's request for a viewed video list registered as the object, and thus allows the viewed video list to be transmitted to a conversation counterpart while providing the messenger service.

In addition, when a path finding service is provided to the accessed user, the object executer 2140 loads the corresponding object from the object management apparatus 2200 according to a user's request for an advertisement for each situation registered as the object, and thus allows the loaded advertisement for each situation to be shown if the user is located in a corresponding area while providing the path finding service.

Furthermore, when the accessed user makes a request for a plurality of SNS posting functions registered as the objects, the object executer 2140 loads the plurality of objects from the object management apparatus 2200, and thus allows the plurality of SNS posting functions for each production company to be simultaneously shown on a particular site.

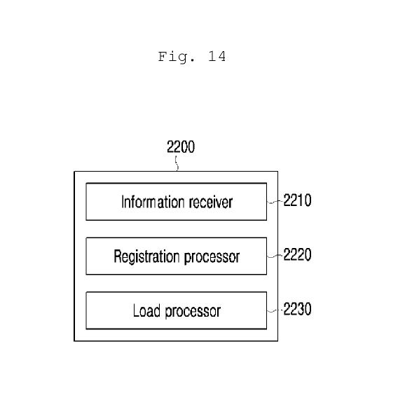

Hereinafter, a more detailed configuration of the object management apparatus 2200 according to an embodiment of the present disclosure will be described with reference to FIG. 14.

As illustrated in FIG. 14, the object management apparatus 2200 includes an information receiver 2210 that receives content information from the service apparatus 2100, a registration processor 2220 that registers the received content information as an object, and a load processor 2230 that extracts and provides the load object.

The information receiver 2210 receives content information selected when the service apparatus 2100 accesses the application service.

More specifically, the information receiver 2210 receives the content information for each application acquired through the user interface on the application service screen from the service apparatus 2100.

For example, the information receiver 2210 receives content information acquired through the user interface in the tool bar form on the service screen from the service apparatus 2100 that accesses the product purchase service according to the user's request, for example, purchased product information or information on a product of interest.

The registration processor 2220 registers the content information received from the service apparatus 2100 as the object for each application service.

More specifically, the registration processor 2220 combines different user identification information (for example, ID) for each of a plurality of service applications into one representative identification information, manages the representative identification information, and identifies the representative identification information designated in accordance with the user identification information transmitted from the service apparatus 2100, so as to map the content information received from the service apparatus 2100 into the identified representative identification information and register the representative identification information as the object for each user.

Further, when the object management apparatus 2200 receives the content information from the service apparatus 2100, the registration processor 2220 identifies whether a resource (for example, execution file) for executing the corresponding content information is included in the content information. When the resource is not included, the object management apparatus 2200 acquires a resource for executing the received content information from a separate apparatus (for example, server) that provides the application service from which the content information is extracted, and registers the resource as the object.

The load processor 2230 extracts and provides the corresponding object according to the load of the registered object.

More specifically, when the object management apparatus 2200 receives an object load request from the service apparatus 2100 that accesses a particular application service, the load processor 2230 provides an inquiry service of the registered object in accordance with the corresponding user or extracts and then provides one or a plurality of objects, so as to allow the provided objects to be simultaneously executed on the currently accessed application service.

At this time, by receiving the user identification information (for example, ID) from the service apparatus 2100, the load processor 2230 identifies the representative identification information designated to correspond to the user identification information and inquires about the object which is mapped into the identified representative identification information, and registered and managed for each user.

Further, by receiving content format information required for the accessed apparatus, for example, a screen size, a resolution, and a driving OS from the service apparatus 2100, the load processor 2230 changes a format of content information registered as the object based on the content format information to support a content format required by the service apparatus 2100.

For example, when an image editing function registered as the object is loaded by the service apparatus 2100 which provides a personal blog service to the accessed user, the load processor 2230 extracts and provides the corresponding object to the service apparatus 2100, so as to allow the image editing function to be additionally shown on the personal blog service serviced through the service apparatus 2100.

Further, when a viewed video list registered as the object is loaded by the service apparatus 2100 that provides a messenger service to the accessed user, the load processor 2230 extracts and provides the corresponding object to the service apparatus 2100, so as to allow the viewed video list to be transmitted to a conversation counterpart while providing the messenger service.

Furthermore, when an advertisement for each situation registered as the object is loaded by the service apparatus 2100 which provides a path finding service to the accessed user, the load processor 2230 extracts and provides the corresponding object to the service apparatus 2100, so as to allow the advertisement for each situation to be shown if the user is located in a corresponding area while providing the path finding service.

In addition, when a plurality of SNS posting functions registered as the objects are loaded by the service apparatus 2100, the load processor 2230 extracts and provides the plurality of registered objects, so as to allow the plurality of SNS posting functions for each production company to be simultaneously shown on a particular site serviced through the service apparatus 2100.

As described above, according to the personal object management system of the present disclosure, as an object sharing function is mutually supported between application services by registering and managing content information designated by a user as an object with respect to each of various application services and providing an inquiry and reuse service of the content information registered as the object to users accessed through various service apparatuses, various demands of users can be satisfied and a new application service in a web environment also can be created.

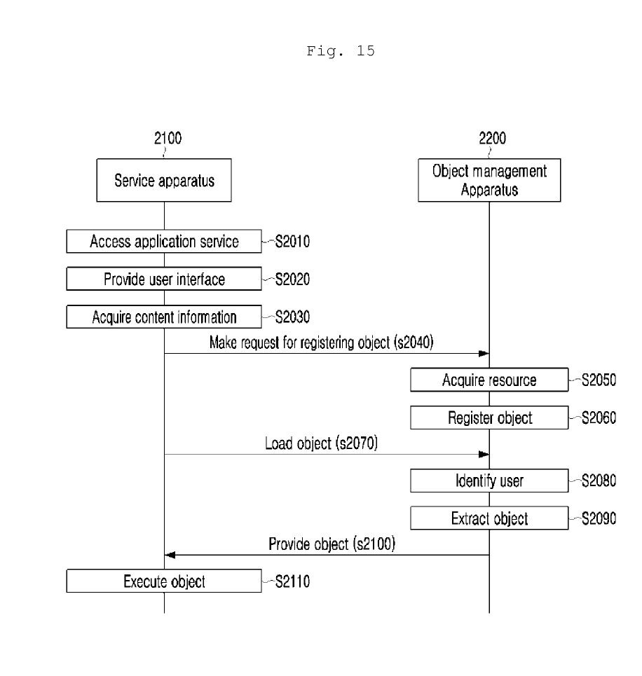

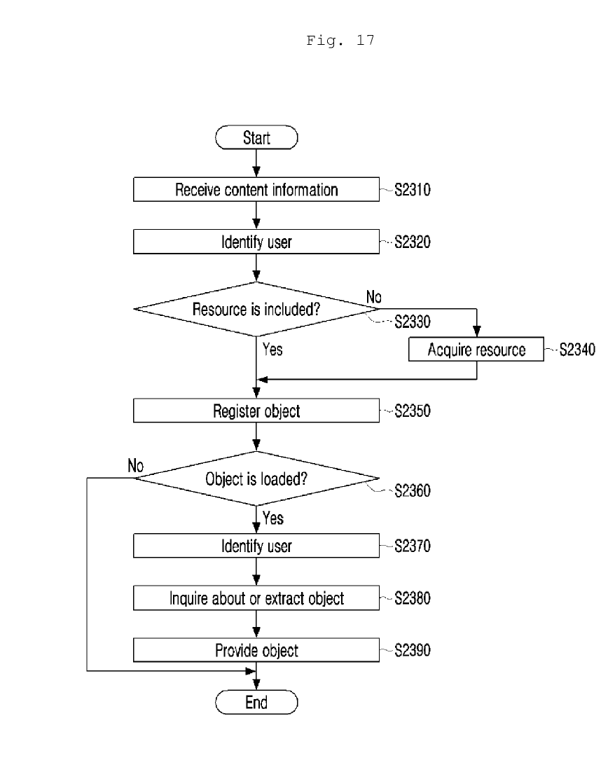

Hereinafter, a personal object management method according to an embodiment of the present disclosure will be described with reference to FIGS. 15 and 17. The same configurations as those illustrated in FIGS. 12 to 14 are assigned the same corresponding reference numerals for the convenience of description.

First, an operation method of the personal object management system according to an embodiment of the present disclosure will be described with reference to FIG. 15.

The service apparatus 2100 accesses an application service according to a user's request in S2010.

Preferably, the service apparatus 2100 accesses application services serviced through the Web or WAP according to a user's request or serviced through the driving of the application installed therein, for example, various types of services such as a personal blog service, a messenger service, a product purchase service, a personal homepage service, a video reproduction service, a music reproduction service, a location based advertisement service, a path finding service, and a Social Networking Service (SNS).

Then, the service apparatus 2100 provides a user interface and acquires content information when accessing the application service in S2020 to S2030.

Preferably, when accessing the application service according to a user's request, the service apparatus 2100 provides a user interface on a service screen to acquire content information corresponding to the corresponding application service, and acquires content information selected by the user from the service screen through the provided user interface.

For example, when accessing the product purchase service, the service apparatus 2100 provides a user interface in a tool bar type on the service screen and receives content information on the service screen by a user's selection on the service screen, that is, a drag and drop action, for example, information on a product purchased by the user or information on a product of interest transmitted through the provided user interface, so as to acquire content information corresponding to the corresponding application service.

When the application service is executed through the driving of the application installed in the service apparatus 2100, the user interface may apply a different type such as selecting a button, not the drag and drop action.

Meanwhile, when the service apparatus 2100 simultaneously accesses a plurality of application services (for example, a first application service and a second application service), the service apparatus 2100 provides a first user interface on a corresponding service screen according to the access to the first application service and provides a second user interface on a corresponding service screen according to the access to the second application service.

Based on the above description, the service apparatus 2100 acquires content information selected by the user from the first application service and content information selected by the user from the second application service through the first user interface, and also acquires content information selected by the user from the second application service and content information selected by the user from the first application service through the second user interface.

For example, when the service apparatus 2100 accesses a product purchase service and a personal homepage service according to a user's request, the service apparatus 2100 provides a user interface in a tool bar form on a service screen of each of the production purchase service and the personal homepage service.

At this time, when content information selected from the product purchase service by the user's selection made on each service screen, that is, the drag and drop action is transmitted to a user interface corresponding to the personal homepage service, the service apparatus 2100 may acquire content information selected from the product purchase service in accordance with the personal homepage service. In contrast, when content information selected from the personal homepage service is transmitted to a user interface corresponding to the product purchase service, the service apparatus 2100 may acquire content information selected from the personal homepage service in accordance with the product purchase service.

Then, the service apparatus 2100 transmits the acquired content information to the object management apparatus 2200 and registers the content information as an object in S2040.

Preferably, by transmitting the content information acquired for each application service to the object management apparatus 2200, the service apparatus 2100 allows the object management apparatus 2200 to register the received content information as the object for each application service.

Further, by transmitting user identification information (for example, ID) for each application service when transmitting the content information, the service apparatus 2100 allows the object management apparatus 220 to combine user identification information for each application service into one representative identification information, so that content information for each application service transmitted in accordance with the same user may be combined into the representative identification information and the representative identification information may be managed.

Subsequently, the object management apparatus 2200 registers the content information received from the service apparatus 2100 as the object for each application service in S2050 to S2060.

Preferably, the object management apparatus 2200 combines different user identification information (for example, ID) for each of a plurality of service applications into one representative identification information, manages the representative identification information, and identifies the representative identification information designated in accordance with the user identification information transmitted from the service apparatus 2100, so as to map the content information received from the service apparatus 2100 into the identified representative identification information and register the representative identification information as the object for each user.

Further, when the object management apparatus 2200 receives the content information from the service apparatus 2100, the object management apparatus 2200 identifies whether a resource (for example, execution file) for executing the corresponding content information is included in the content information. When the resource is not included, the object management apparatus 2200 acquires a resource for executing the received content information from a separate apparatus (for example, server) that provides the application service from which the content information is extracted, and registers the resource as the object.

Furthermore, when accessing a particular application service, the service apparatus 2100 loads a registered object in S2070.

Preferably, when the service apparatus 2100 receives an object load request from the user while accessing the particular application service, the service apparatus 2100 makes a request for the registered object for each application service to the object management apparatus 2200.

At this time, by transmitting the user identification information (for example, ID) to the object management apparatus 2200 when the object is loaded, the service apparatus 2100 acquires representative identification information designated to correspond to the user identification information and allows the object which is mapped into the identified representative identification information, and registered and managed for each user to be inquired.

Further, by transmitting content format information required for each service apparatus, for example, a screen size, a resolution, and a driving OS to the object management apparatus 2200 when the object is loaded, the service apparatus 2100 allows the object management apparatus 2200 to change a format of content information registered as the object in accordance with a content format required for the service apparatus 2100 that loads the object based on the content format information and to provide the changed type of content information.

Thereafter, according to the load of the registered object, the object management apparatus 2200 extracts and provides the corresponding object in S2080 to S2110.

Preferably, when receiving an object load request from the service apparatus 2100 that accesses a particular application service, the object management apparatus 2200 provides an inquiry service of the registered object in accordance with the corresponding user or extracts and then provides one or a plurality of objects, so as to allow the provided objects to be simultaneously executed on the currently accessed application service.

At this time, by receiving the user identification information (for example, ID) from the service apparatus 2100, the object management apparatus 2200 identifies the representative identification information designated to correspond to the user identification information and inquires about the object which is mapped into the identified representative identification information, and registered and managed for each user.

Further, by receiving content format information required for the accessed apparatus, for example, a screen size, a resolution, and a driving OS from the service apparatus 2100, the object management apparatus 2200 changes a format of content information registered as the object based on the content format information to support a content format required by the service apparatus 2100.

For example, when an image editing function registered as the object is loaded by the service apparatus 2100 which provides a personal blog service to the accessed user, the object management apparatus 2200 extracts and provides the corresponding object to the service apparatus 2100, so as to allow the image editing function to be additionally shown on the personal blog service serviced through the service apparatus 2100.

Further, when a viewed video list registered as the object is loaded by the service apparatus 2100 that provides a messenger service to the accessed user, the object management apparatus 2200 extracts and provides the corresponding object to the service apparatus 2100, so as to allow the viewed video list to be transmitted to a conversation counterpart while providing the messenger service.

Furthermore, when an advertisement for each situation registered as the object is loaded by the service apparatus 2100 which provides a path finding service to the accessed user, the object management apparatus 2200 extracts and provides the corresponding object to the service apparatus 2100, so as to allow the advertisement for each situation to be shown if the user is located in a corresponding area while providing the path finding service.

In addition, when a plurality of SNS posting functions registered as the objects are loaded by the service apparatus 2100, the object management apparatus 2200 extracts and provides the plurality of registered objects, so as to allow the plurality of SNS posting functions for each production company to be simultaneously shown on a particular site serviced through the service apparatus 2100.

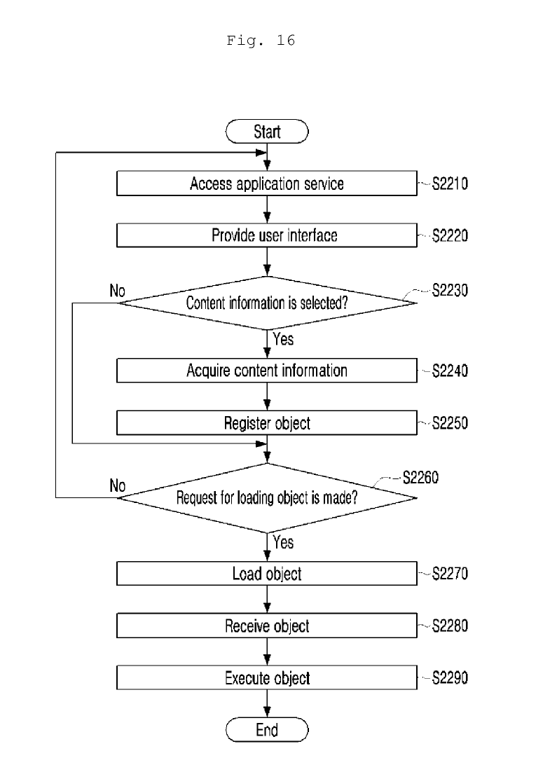

Hereinafter, the operation method of the service apparatus 2100 according to an embodiment of the present disclosure will be described with reference to FIG. 16.

First, the service apparatus 2100 accesses an application service according to a user's request in S2210.

Preferably, the service accessing unit 2110 accesses application services serviced through the Web or WAP according to a user's request or serviced through the driving of the application installed therein, for example, various types of services such as a personal blog service, a messenger service, a product purchase service, a personal homepage service, a video reproduction service, a music reproduction service, a location based advertisement service, a path finding service, and a Social Networking Service (SNS).

Then, the service apparatus 2100 provides a user interface and acquires content information when accessing the application service in S2220 to S2240.

Preferably, when the service apparatus 2100 accesses the application service according to the user's request, the information acquiring unit 2120 provides a user interface on a service screen to acquire content information corresponding to the corresponding application service, and acquires content information selected by the user from the service screen through the provided user interface.

For example, when accessing the product purchase service, the service apparatus 2100 provides a user interface in a tool bar type on the service screen and receives content information on the service screen by a user's selection on the service screen, that is, a drag and drop action, for example, information on a product purchased by the user or information on a product of interest transmitted through the provided user interface, so as to acquire content information corresponding to the corresponding application service.

When the application service is executed through the driving of the application installed in the service apparatus 2100, the user interface may apply a different type such as selecting a button, not the drag and drop action.

Meanwhile, when the service apparatus 2100 simultaneously accesses a plurality of application services (for example, a first application service and a second application service), the information acquiring unit 2120 provides a first user interface on a corresponding service screen according to the access to the first application service and provides a second user interface on a corresponding service screen according to the access to the second application service.

Based on the above description, the information acquiring unit 2120 acquires content information selected by the user from the first application service and content information selected by the user from the second application service through the first user interface, and also acquires content information selected by the user from the second application service and content information selected by the user from the first application service through the second user interface.

For example, when the service apparatus 2100 accesses a product purchase service and a personal homepage service according to a user's request, the information acquiring unit 2120 provides a user interface in a tool bar form on a service screen of each of the production purchase service and the personal homepage service.

At this time, when content information selected from the product purchase service by the user's selection made on each service screen, that is, the drag and drop action is transmitted to a user interface corresponding to the personal homepage service, the information acquiring unit 2120 may acquire content information selected from the product purchase service in accordance with the personal homepage service. In contrast, when content information selected from the personal homepage service is transmitted to a user interface corresponding to the product purchase service, the information acquiring unit 2120 may acquire content information selected from the personal homepage service in accordance with the product purchase service.

Then, the service apparatus 2100 transmits the acquired content information to the object management apparatus 2200 and registers the content information as an object in S2250.

Preferably, by transmitting the content information acquired for each application service to the object management apparatus 2200, the object registering unit 2130 allows the object management apparatus 2200 to register the received content information as the object for each application service.

Further, by transmitting user identification information (for example, ID) for each application service when transmitting the content information, the object registering unit 2130 allows the object management apparatus 220 to combine user identification information for each application service into one representative identification information, so that content information for each application service transmitted in accordance with the same user may be combined into the representative identification information and the representative identification information may be managed.

Thereafter, when accessing a particular application service, the service apparatus 2100 loads and executes a registered object in S2260 to S2290.

Preferably, when the service apparatus 2100 receives an object load request from the user while accessing a particular application service, the object executer 2140 receives an inquiry service of the object registered for each application from the object management apparatus 2200 or loads one or a plurality of objects, so as to allow the loaded objects to be simultaneously executed on the currently accessed application service.

At this time, by transmitting the user identification information (for example, ID) to the object management apparatus 2200 when the object is loaded, the object executer 2140 acquires representative identification information designated to correspond to the user identification information and allows the object which is mapped into the identified representative identification information, and registered and managed for each user to be inquired.

Further, by transmitting content format information required for each service apparatus, for example, a screen size, a resolution, and a driving OS to the object management apparatus 2200 when the object is loaded, the object executer 2140 allows the object management apparatus 2200 to change a format of content information registered as the object in accordance with a content format required for the service apparatus 2100 that loads the object based on the content format information and to provide the changed type of content information.

For example, when a personal blog service is provided to the accessed user, the object executer 2140 loads the corresponding object from the object management apparatus 2200 according to a user's request for an image editing function registered as the object, and thus allows the image editing function to be additionally shown on the personal blog service and executed on the personal blog service.

Further, when a messenger service is provided to the accessed user, the object executer 2140 loads the corresponding object from the object management apparatus 2200 according to a user's request for a viewed video list registered as the object, and thus allows the viewed video list to be transmitted to a conversation counterpart while providing the messenger service.

In addition, when a path finding service is provided to the accessed user, the object executer 2140 loads the corresponding object from the object management apparatus 2200 according to a user's request for an advertisement for each situation registered as the object, and thus allows the loaded advertisement for each situation to be shown if the user is located in a corresponding area while providing the path finding service.

Furthermore, when the accessed user makes a request for a plurality of SNS posting functions registered as the objects, the object executer 2140 loads the plurality of objects from the object management apparatus 2200, and thus allows the plurality of SNS posting functions for each production company to be simultaneously shown on a particular site.

Hereinafter, the operation method of the object management apparatus 2200 according to an embodiment of the present disclosure will be described with reference to FIG. 17.

Then, the object management apparatus 2200 receives selected content information when the service apparatus 2100 accesses the application service in S2310.

Preferably, the information receiver 2210 receives the content information for each application acquired through the user interface on the application service screen from the service apparatus 2100.

For example, the information receiver 2210 receives content information acquired through the user interface in the tool bar form on the service screen from the service apparatus 2100 that accesses the product purchase service according to the user's request, for example, purchased product information or information on a product of interest.

Then, the object management apparatus 2200 registers the content information received from the service apparatus 2100 as the object for each application service in S2320 to S2350.

Preferably, the registration processor 2220 combines different user identification information (for example, ID) for each of a plurality of service applications into one representative identification information, manages the representative identification information, and identifies the representative identification information designated in accordance with the user identification information transmitted from the service apparatus 2100, so as to map the content information received from the service apparatus 2100 into the identified representative identification information and register the representative identification information as the object for each user.

Further, when the object management apparatus 2200 receives the content information from the service apparatus 2100, the registration processor 2220 identifies whether a resource (for example, execution file) for executing the corresponding content information is included in the content information. When the resource is not included, the object management apparatus 2200 acquires a resource for executing the received content information from a separate apparatus (for example, server) that provides the application service from which the content information is extracted, and registers the resource as the object.

Thereafter, according to the load of the registered object, the corresponding object is extracted and provided in S2360 to S2390.

Preferably, when an object load request is received from the service apparatus 2100 that accesses a particular application service, the load processor 2230 provides an inquiry service of the registered object in accordance with the corresponding user or extracts and then provides one or a plurality of objects, so as to allow the provided objects to be simultaneously executed on the application service which the service apparatus 2100 currently accesses.

At this time, by receiving the user identification information (for example, ID) from the service apparatus 2100, the load processor 2230 identifies the representative identification information designated to correspond to the user identification information and inquires about the object which is mapped into the identified representative identification information, and registered and managed for each user.

Further, by receiving content format information required for the accessed apparatus, for example, a screen size, a resolution, and a driving OS from the service apparatus 2100, the load processor 2230 changes a format of content information registered as the object based on the content format information to support a content format required by the service apparatus 2100.

For example, when an image editing function registered as the object is loaded by the service apparatus 2100 which provides a personal blog service to the accessed user, the load processor 2230 extracts and provides the corresponding object to the service apparatus 2100, so as to allow the image editing function to be additionally shown on the personal blog service serviced through the service apparatus 2100.

Further, when a viewed video list registered as the object is loaded by the service apparatus 2100 that provides a messenger service to the accessed user, the load processor 2230 extracts and provides the corresponding object to the service apparatus 2100, so as to allow the viewed video list to be transmitted to a conversation counterpart while providing the messenger service.

Furthermore, when an advertisement for each situation registered as the object is loaded by the service apparatus 2100 which provides a path finding service to the accessed user, the load processor 2230 extracts and provides the corresponding object to the service apparatus 2100, so as to allow the advertisement for each situation to be shown if the user is located in a corresponding area while providing the path finding service.

In addition, when a plurality of SNS posting functions registered as the objects are loaded by the service apparatus 2100, the load processor 2230 extracts and provides the plurality of registered objects, so as to allow the plurality of SNS posting functions for each production company to be simultaneously shown on a particular site serviced through the service apparatus 2100.

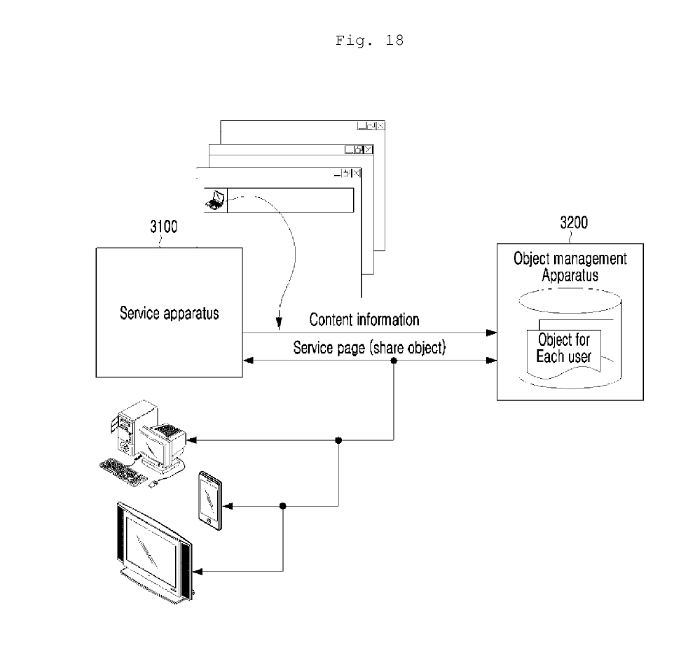

FIG. 18 illustrates a schematic configuration of a personal object sharing system according to an embodiment of the present disclosure.

As illustrated in FIG. 18, the system includes a service apparatus 3100 that transmits content information selected for each application service to make a request for registering the content information as an object and accesses a service page for each user to receive one or more sharing services of the registered object and an object management apparatus 3200 that registers the content information received from the service apparatus as the object to configure the service page for each user and provides the sharing service of the registered object through the service page.

The service apparatus 3100 refers to a terminal apparatus for accessing various application services through the Web or WAP according to a user's request, and may correspond to a Personal Computer (PC), a smart phone, and an Internet Protocol TeleVision (IPTV).

The service apparatus 3100 accesses an application service according to a user's request.

More specifically, the service apparatus 3100 accesses application services serviced through the Web or WAP according to a user's request or serviced through the driving of the application installed therein, for example, various types of services such as a personal blog service, a messenger service, a product purchase service, a personal homepage service, a video reproduction service, a music reproduction service, a location based advertisement service, a path finding service, and a Social Networking Service (SNS).

The service apparatus 3100 provides a user interface and acquires content information when accessing the application service.

More specifically, when accessing the application service according to a user's request, the service apparatus 3100 provides a user interface on a service screen to acquire content information corresponding to the corresponding application service, and acquires content information selected by the user from the service screen through the provided user interface.

For example, when accessing the product purchase service, the service apparatus 3100 provides a user interface in a tool bar type on the service screen and receives content information on the service screen by a user's selection on the service screen, that is, a drag and drop action, for example, information on a product purchased by the user or information on a product of interest transmitted through the provided user interface, so as to acquire content information corresponding to the corresponding application service.

The service apparatus 3100 transmits the acquired content information to the object management apparatus 3200 and registers the content information as an object.

More specifically, by transmitting the acquired content information to the object management apparatus 3200 to make a request for registering the content information as the object when accessing the application service, the service apparatus 3100 allows the object management apparatus 3200 to register the received content information as the object and configure a service page for each user.

At this time, when transmitting the content information, the service apparatus 3100 transmits user identification information (for example, ID), so that the object may be registered for each user.

Further, by additionally transmitting access information on the content information as well as the user identification information, the service apparatus 3100 allows the access to the content information to be induced based on the transmitted access information when the object is shared through the service page for each user provided by the object management apparatus 3200.

Further, by additionally transmitting sharing setting information on the content information requested to be registered as the object, the service apparatus 3100 designates a counterpart with which the content information registered as the object can be shared on the service page or designates the number of times that the registered content information can be moved and added between users based on the sharing setting information when the object is shared through the service page for each user provided by the object management apparatus 3200.

By additionally transmitting content formation information on the content information when the object of the content information is registered, the service apparatus 3100 allows the object management apparatus 3200 to change a format of the content information registered as the object on the service page based on the content format information according to a service page format required by the particular accessed service apparatus and provide the changed format of the content information.

The service apparatus 3100 accesses a service page for each user and receives sharing service of the registered object.

More specifically, the service apparatus 3100 receives the service page for each user from the object management apparatus 3200 according to a user's request, so as to support a sharing service of the registered object on the received service page.

For example, by receiving the service page of the corresponding user from the object management apparatus 3200 according to the user's request, the service apparatus 3100 allows the user to inquire about the objects of the user chronologically registered on the service page or to move and add a particular object registered on the service page to a blog of the user as additional content information.

Further, by receiving a service page of another user from the object management apparatus 3200 according to a user's request, the service apparatus 3100 provides support such that the user moves and adds particular content information registered as the object on the received service page of another user to the service page of the user, so that the users may share the registered object on the service page.

The object management apparatus 3200 receives selected content information when the service apparatus 3100 accesses the application service.

More specifically, the object management apparatus 3200 receives the content information acquired through the user interface on the application service screen from the service apparatus 3100.

For example, the object management apparatus 3200 receives content information acquired through the user interface in the tool bar form on the service screen from the service apparatus 3100 that accesses the product purchase service according to the user's request, for example, purchased product information or information on a product of interest.

The object management apparatus 3200 configures the service page based on the content information received from the service apparatus 3100.

More specifically, the object management apparatus 3200 distinguishes the user with reference to user identification information (for example, ID) included in the content information received from the service apparatus 3100 and chronologically registers the received content information as the object, so as to configure the service page for each user.

At this time, when configuring the object of the content information, the object management apparatus 3200 additionally registers access information on the particular content information to configure the service page. Accordingly, when the object is shared through the service page, the access to the content information registered as the object can be induced based on the access information.

Further, by additionally registering sharing setting information on the content information requested to be registered as the object to configure the service page, the service apparatus 3100 limits counterparts with which the corresponding content information registered as the object can be shared or limits the number of times that the registered content information can be moved and added between the users based on the sharing setting information when the object is shared through the service page.

In addition, by additionally registering content formation information on the content information requested to be registered as the object to configure the service page, the service apparatus 3100 allows the object management apparatus 3200 to change a format of the content information registered as the object on the service page based on the content format information according to a service page format required by the particular accessed service apparatus, for example, a screen size or a resolution and provide the changed format of the content information.

The object management apparatus 3200 provides the configured service page for each user to provide a sharing service of the registered object.

More specifically, when the object management apparatus 3200 receives a request for the service page from the service apparatus 3100, the object management apparatus 3200 inquires about the service page through a user identification and provides the inquired service page, so as to provide a sharing service of the registered object on the corresponding service page.

At this time, in providing the service page, the object management apparatus 3200 changes a format of the content information registered as the object on the service page based on the content format information according to a service page format required by the particular accessed service apparatus, for example, a screen size or a resolution and provides the changed format of the content information with reference to the additionally registered content format information in accordance with the object.

For example, the object management apparatus 3200 inquires about the service page of the corresponding user according to a user's request through the service apparatus 3100 and provides the service page, so as to allow the user to inquire about objects of the user chronologically registered in the service page or to move and add a particular object registered in the service page to a blog of the user as additional content information.

Further, the object management apparatus 3200 inquires about a service page of another user according to a user's request through the service apparatus 3100 and provides the service page, so as to allow the user to move and add particular content information registered as the object in the received service page of another user to the service page of the user, so that the object registered in the service page can be shared between the users.

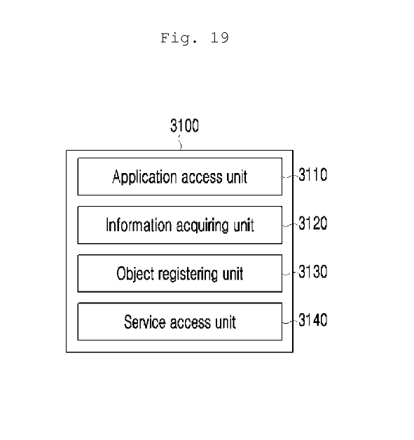

Hereinafter, a more detailed configuration of the service apparatus 3100 according to an embodiment of the present disclosure will be described with reference to FIG. 19.

As illustrated in FIG. 19, the service apparatus 3100 includes an application accessing unit 3110 that accesses an application service according to a user's request, an information acquiring unit 3120 that acquires content information through provision of a user interface, an object registering unit 3130 that transmits the acquired content information to make a request for registering the content information as an object, and a service accessing unit 3140 that accesses a service page for each user to receive one or more sharing services of the registered object.

The application accessing unit 3110 accesses an application service according to a user's request.

More specifically, the service accessing unit 3110 accesses application services serviced through the Web or WAP according to a user's request or serviced through the driving of the application installed therein, for example, various types of services such as a personal blog service, a messenger service, a product purchase service, a personal homepage service, a video reproduction service, a music reproduction service, a location based advertisement service, a path finding service, and a Social Networking Service (SNS).

The information acquiring unit 3120 provides a user interface and acquires content information when accessing the application service.

More specifically, when the service accessing unit 3120 accesses the application service, the information acquiring unit 2120 provides a user interface on a service screen to acquire content information corresponding to the corresponding application service, and acquires content information selected by the user from the service screen through the provided user interface.

For example, when the service apparatus 3100 accesses a product purchase service, the information acquiring unit 3120 provides a user interface in a tool bar type on the service screen and receives content information on the service screen by a user's selection on the service screen, that is, a drag and drop action, for example, information on a product purchased by the user or information on a product of interest transmitted through the provided user interface, so as to acquire content information corresponding to the corresponding application service.

The object registering unit 3130 transmits the acquired content information to the object management apparatus 3200 and registers the content information as an object.

More specifically, by transmitting the acquired content information to the object management apparatus 3200 to make a request for registering the content information as the object when accessing the application service, the object registering unit 3130 allows the object management apparatus 3200 to register the received content information as the object and configure a service page for each user.

At this time, when transmitting the content information, the object registering unit 3130 transmits user identification information (for example, ID), so that the object may be registered for each user.

Further, by additionally transmitting access information on the content information as well as the user identification information, the object registering unit 3130 allows the access to the content information to be induced based on the transmitted access information when the object is shared through the service page for each user provided by the object management apparatus 3200.

Further, by additionally transmitting sharing setting information on the content information requested to be registered as the object, the object registering unit 3130 designates a counterpart with which the content information registered as the object can be shared on the service page or designates the number of times that the registered content information can be moved and added between users based on the sharing setting information when the object is shared through the service page for each user provided by the object management apparatus 3200.

By additionally transmitting content formation information on the content information when the object of the content information is registered, the object registering unit 3130 allows the object management apparatus 3200 to change a format of the content information registered as the object on the service page based on the content format information according to a service page format required by the particular accessed service apparatus and provide the changed format of the content information.

The service accessing unit 3140 accesses a service page for each user and receives a sharing service of the registered object.

More specifically, the service accessing unit 3140 receives the service page for each user from the object management apparatus 3200 according to a user's request, so as to support the sharing service of the registered object on the received service page.

For example, by receiving the service page of the corresponding user from the object management apparatus 3200 according to the user's request, the service accessing unit 3140 allows the user to inquire about objects of the user chronologically registered in the service page or provides support such that a particular object registered in the service page is moved and added to a blog of the user as additional content information.

Further, by receiving a service page of another user from the object management apparatus 3200 according to a user's request, the service accessing unit 3140 provides support such that the user moves and adds particular content information registered as the object in the received service page of another user to the service page of the user, so that the users may share the registered object on the service page.

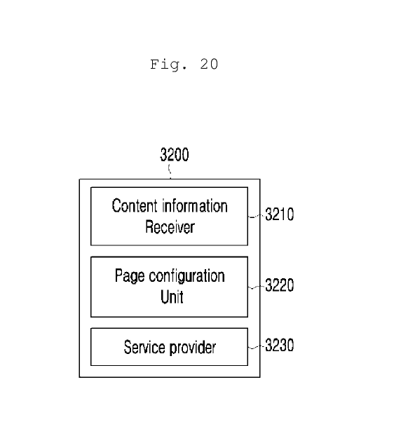

Hereinafter, a more detailed configuration of the object management apparatus 3200 according to an embodiment of the present disclosure will be described with reference to FIG. 20.

As illustrated in FIG. 20, the object management apparatus 3200 includes a content information receiver 3210 that receives content information from the service apparatus 3100, a page configuration unit 3220 that registers the received content information as an object to configure a service page for each user, and a service provider 3230 that provides a service page for each user to provide a sharing service of the registered object.

The content information receiver 3210 receives selected content information when the service apparatus 3100 accesses the application service from.

More specifically, the content information receiver 3210 receives the content information acquired through the user interface on the application service screen from the service apparatus 3100.

For example, the content information receiver 3210 receives content information acquired through the user interface in the tool bar form on the service screen from the service apparatus 3100 that accesses the product purchase service according to the user's request, for example, purchased product information or information on a product of interest.

The page configuration unit 3220 configures the service page based on the content information received from the service apparatus 3100.

More specifically, the page configuration unit 3220 distinguishes the user with reference to user identification information (for example, ID) included in the content information received from the service apparatus 3100 and chronologically registers the received content information as the object, so as to configure the service page for each user.

At this time, when configuring the object of the content information, the page configuration unit 3220 additionally registers access information on the particular content information to configure the service page. Accordingly, when the object is shared through the service page, the access to the content information registered as the object can be induced based on the access information.

Further, by additionally registering sharing setting information on the content information requested to be registered as the object to configure the service page, the page configuration unit 3220 limits counterparts with which the corresponding content information registered as the object can be shared or limits the number of times that the registered content information can be moved and added between the users based on the sharing setting information when the object is shared through the service page.

In addition, by additionally registering content formation information on the content information requested to be registered as the object to configure the service page, the page configuration unit 3220 allows the object management apparatus 3200 to change a format of the content information registered as the object on the service page based on the content format information according to a service page format required by the particular accessed service apparatus, for example, a screen size or a resolution and provide the changed format of the content information.

The service provider 3230 provides the configured service page for each user to provide a sharing service of the registered object.

More specifically, when a request for the service page is made by the service apparatus 3100, the service provider 3230 inquires about the service page through a user identification and provides the inquired service page, so as to provide a sharing service of the registered object on the corresponding service page.

At this time, in providing the service page, the service provider 3230 limits counterparts with which the corresponding content information registered as the object can be shared and limits the number of times that the object is shared with reference to the sharing setting information additionally registered in accordance with the object.

Further, in providing the service page, the service provider 3230 changes a format of the content information registered as the object on the service page based on the content format information according to a service page format required by the particular accessed service apparatus, for example, a screen size or a resolution and provides the changed format of the content information with reference to the content format information additionally registered in accordance with the object.

For example, the service provider 3230 inquires about the service page of the corresponding user according to a user's request through the service apparatus 3100 and provides the service page, so as to allow the user to inquire about objects of the user chronologically registered in the service page or to move and add a particular object registered in the service page to a blog of the user as additional content information.

Further, the service provider 3230 inquires about a service page of another user according to a user's request through the service apparatus 3100 and provides the service page, so as to allow the user to move and add particular content information registered as the object in the received service page of another user to the service page of the user, so that the object registered in the service page can be shared between the users.

As described above, according to the personal object sharing system of the present disclosure, it is possible to satisfy various demands of users and also create a new service in a web environment by registering content information according to a user's designation as an object to configure a service page and providing a sharing service of the registered object to users who access the corresponding service page when various application services are used.

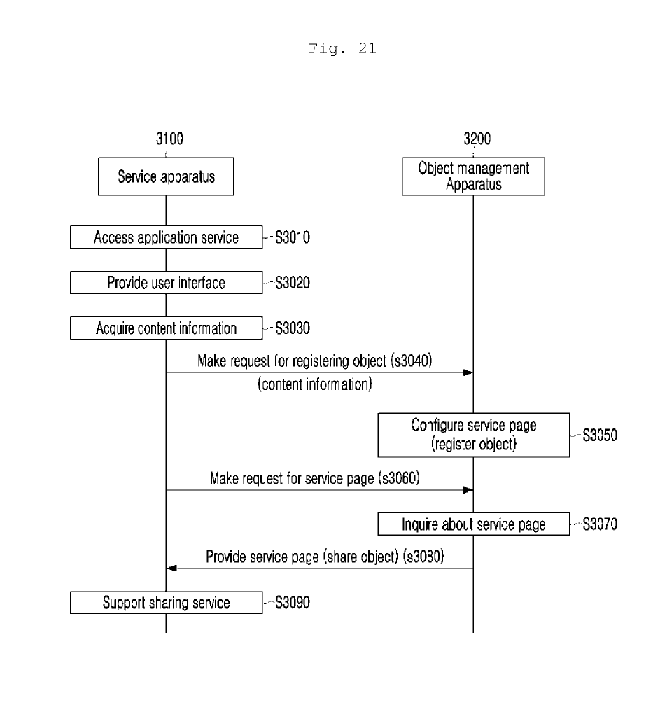

Hereinafter, a personal object sharing method according to an embodiment of the present disclosure will be described with reference to FIGS. 21 to 6. The same configurations as those illustrated in FIGS. 18 to 20 are assigned the same corresponding reference numerals for the convenience of description.

First, an operation method of the personal object sharing system according to an embodiment of the present disclosure will be described with reference to FIG. 21.

The service apparatus 3100 accesses an application service according to a user's request in S3010.

Preferably, the service apparatus 3100 accesses application services serviced through the Web or WAP according to a user's request or serviced through the driving of the application installed therein, for example, various types of services such as a personal blog service, a messenger service, a product purchase service, a personal homepage service, a video reproduction service, a music reproduction service, a location based advertisement service, a path finding service, and a Social Networking Service (SNS).

Then, the service apparatus 3100 provides a user interface and acquires content information when accessing the application service in S3020 to S3030.

Preferably, when accessing the application service according to a user's request, the service apparatus 3100 provides a user interface on a service screen to acquire content information corresponding to the corresponding application service, and acquires content information selected by the user from the service screen through the provided user interface.

For example, when accessing the product purchase service, the service apparatus 3100 provides a user interface in a tool bar type on the service screen and receives content information on the service screen by a user's selection on the service screen, that is, a drag and drop action, for example, information on a product purchased by the user or information on a product of interest transmitted through the provided user interface, so as to acquire content information corresponding to the corresponding application service.

Then, the service apparatus 3100 transmits the acquired content information to the object management apparatus 3200 and registers the content information as an object in S3040.

Preferably, by transmitting the acquired content information to the object management apparatus 3200 to make a request for registering the content information as the object when accessing the application service, the service apparatus 3100 allows the object management apparatus 3200 to register the received content information as the object and configure a service page for each user.

Subsequently, the object management apparatus 3200 configures the service page based on the content information received from the service apparatus 3100 in S3050.

Preferably, the object management apparatus 3200 distinguishes the user with reference to user identification information (for example, ID) included in the content information received from the service apparatus 3100 and chronologically registers the received content information as the object, so as to configure the service page for each user.

At this time, when configuring the object of the content information, the object management apparatus 3200 additionally registers access information on the particular content information to configure the service page. Accordingly, when the object is shared through the service page, the access to the content information registered as the object can be induced based on the access information.

Further, by additionally registering sharing setting information on the content information requested to be registered as the object to configure the service page, the service apparatus 3100 limits counterparts with which the corresponding content information registered as the object can be shared or limits the number of times that the registered content information can be moved and added between the users based on the sharing setting information when the object is shared through the service page.

In addition, by additionally registering content formation information on the content information requested to be registered as the object to configure the service page, the service apparatus 3100 allows the object management apparatus 3200 to change a format of the content information registered as the object on the service page based on the content format information according to a service page format required by the particular accessed service apparatus, for example, a screen size or a resolution and provide the changed format of the content information.

Thereafter, the object management apparatus 3200 provides the configured service page for each user to provide a sharing service of the registered object in S3070 to S3090.

Preferably, when the object management apparatus 3200 receives a request for the service page from the service apparatus 3100, the object management apparatus 3200 inquires about the service page through a user identification and provides the inquired service page, so as to provide a sharing service of the registered object on the corresponding service page.

At this time, in providing the service page, the object management apparatus 3200 changes a format of the content information registered as the object on the service page based on the content format information according to a service page format required by the particular accessed service apparatus, for example, a screen size or a resolution and provides the changed format of the content information with reference to the additionally registered content format information in accordance with the object.

For example, the object management apparatus 3200 inquires about the service page of the corresponding user according to a user's request through the service apparatus 3100 and provides the service page, so as to allow the user to inquire about objects of the user chronologically registered in the service page or to move and add a particular object registered in the service page to a blog of the user as additional content information.

Further, the object management apparatus 3200 inquires about a service page of another user according to a user's request through the service apparatus 3100 and provides the service page, so as to allow the user to move and add particular content information registered as the object in the received service page of another user to the service page of the user, so that the object registered in the service page can be shared between the users.

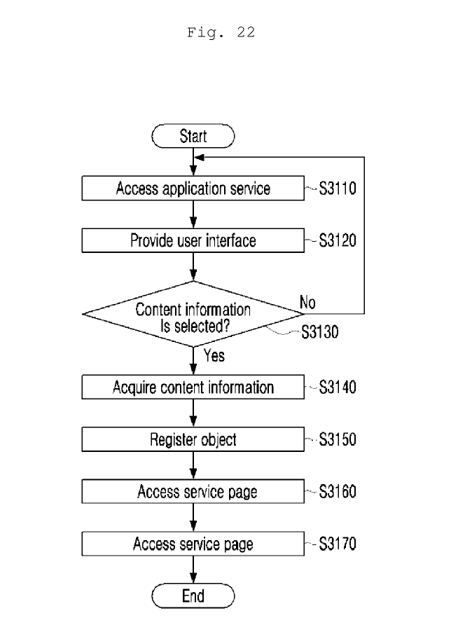

Hereinafter, the operation method of the service apparatus 3100 according to an embodiment of the present disclosure will be described with reference to FIG. 22.

First, the service apparatus 3100 accesses an application service according to a user's request in S3110.

Preferably, the service accessing unit 3110 accesses application services serviced through the Web or WAP according to a user's request or serviced through the driving of the application installed therein, for example, various types of services such as a personal blog service, a messenger service, a product purchase service, a personal homepage service, a video reproduction service, a music reproduction service, a location based advertisement service, a path finding service, and a Social Networking Service (SNS).

Then, the service apparatus 3100 provides a user interface and acquires content information when accessing the application service in S3120 to S3140.

Preferably, when the service apparatus 3100 accesses the application service according to the user's request, the information acquiring unit 3120 provides a user interface on a service screen to acquire content information corresponding to the corresponding application service, and acquires content information selected by the user from the service screen through the provided user interface.

For example, when the service apparatus 3100 accesses a product purchase service, the information acquiring unit 3120 provides a user interface in a tool bar type on the service screen and receives content information on the service screen by a user's selection on the service screen, that is, a drag and drop action, for example, information on a product purchased by the user or information on a product of interest transmitted through the provided user interface, so as to acquire content information corresponding to the corresponding application service.

Then, the service apparatus 3100 transmits the acquired content information to the object management apparatus 3200 and registers the content information as an object in S3150.

Preferably, by transmitting the acquired content information to the object management apparatus 3200 to make a request for registering the content information as the object when accessing the application service, the object registering unit 3130 allows the object management apparatus 3200 to register the received content information as the object and configure a service page for each user.

At this time, when transmitting the content information, the object registering unit 3130 transmits user identification information (for example, ID), so that the object may be registered for each user.

Further, by additionally transmitting access information on the content information as well as the user identification information, the object registering unit 3130 allows the access to the content information to be induced based on the transmitted access information when the object is shared through the service page for each user provided by the object management apparatus 3200.

Further, by additionally transmitting sharing setting information on the content information requested to be registered as the object, the object registering unit 3130 designates a counterpart with which the content information registered as the object can be shared on the service page or designates the number of times that the registered content information can be moved and added between users based on the sharing setting information when the object is shared through the service page for each user provided by the object management apparatus 3200.

By additionally transmitting content formation information on the content information when the object of the content information is registered, the object registering unit 3130 allows the object management apparatus 3200 to change a format of the content information registered as the object on the service page based on the content format information according to a service page format required by the particular accessed service apparatus and provide the changed format of the content information.

Thereafter, the service apparatus 3100 accesses the service page for each user to receive a sharing service of the registered object in S3160 to S3170.

Preferably, by receiving the service page for each user from the object management apparatus 3200 according to a user's request, the service accessing unit 3140 supports the sharing service of the registered object on the received service page.

For example, by receiving the service page of the corresponding user from the object management apparatus 3200 according to the user's request, the service accessing unit 3140 allows the user to inquire about objects of the user chronologically registered in the service page or provides support such that a particular object registered in the service page is moved and added to a blog of the user as additional content information.

Further, by receiving a service page of another user from the object management apparatus 3200 according to a user's request, the service accessing unit 3140 provides support such that the user moves and adds particular content information registered as the object in the received service page of another user to the service page of the user, so that the users may share the registered object on the service page.

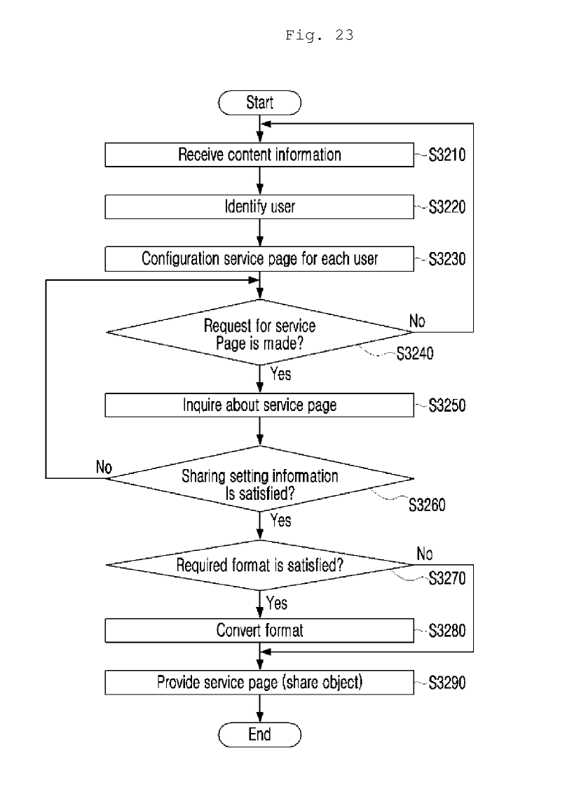

Hereinafter, the operation method of the object management apparatus 3200 according to an embodiment of the present disclosure will be described with reference to FIG. 23.

First, the object management apparatus 3200 receives selected content information when the service apparatus 3100 accesses the application service in S3210.

Preferably, the content information receiver 3210 receives the content information acquired through the user interface on the application service screen from the service apparatus 3100.

For example, the content information receiver 3210 receives content information acquired through the user interface in the tool bar form on the service screen from the service apparatus 3100 that accesses the product purchase service according to the user's request, for example, purchased product information or information on a product of interest.

Then, the object management apparatus 3200 configures the service page based on the content information received from the service apparatus 3100 in S3220 to S3250.

Preferably, the page configuration unit 3220 distinguishes the user with reference to user identification information (for example, ID) included in the content information received from the service apparatus 3100 and chronologically registers the received content information as the object, so as to configure the service page for each user.

At this time, when the object of the content information is registered, the page configuration unit 3220 additionally registers access information on the particular content information to configure the service page. Accordingly, when the object is shared through the service page, the access to the content information registered as the object can be induced based on the access information.

Further, by additionally registering sharing setting information on the content information requested to be registered as the object to configure the service page, the page configuration unit 3220 limits counterparts with which the corresponding content information registered as the object can be shared or limits the number of times that the registered content information can be moved and added between the users based on the sharing setting information when the object is shared through the service page.

In addition, by additionally registering content formation information on the content information requested to be registered as the object to configure the service page, the page configuration unit 3220 allows the object management apparatus 3200 to change a format of the content information registered as the object on the service page based on the content format information according to a service page format required by the particular accessed service apparatus, for example, a screen size or a resolution and provide the changed format of the content information.

Thereafter, the object management apparatus 3200 provides the service page for each user to provide a sharing service of the registered object in S3250 to S3290.

Preferably, when a request for the service page is made by the service apparatus 3100, the service provider 3230 inquires about the service page through a user identification and provides the inquired service page, so as to provide a sharing service of the registered object on the corresponding service page.

At this time, in providing the service page, the service provider 3230 limits counterparts with which the corresponding content information registered as the object can be shared and limits the number of times that the object is shared with reference to the sharing setting information additionally registered in accordance with the object.

Further, in providing the service page, the service provider 3230 changes a format of the content information registered as the object on the service page based on the content format information according to a service page format required by the particular accessed service apparatus, for example, a screen size or a resolution and provides the changed format of the content information with reference to the content format information additionally registered in accordance with the object.

For example, the service provider 3230 inquires about the service page of the corresponding user according to a user's request through the service apparatus 3100 and provides the service page, so as to allow the user to inquire about objects of the user chronologically registered in the service page or to move and add a particular object registered in the service page to a blog of the user as additional content information.

Further, the service provider 3230 inquires about a service page of another user according to a user's request through the service apparatus 3100 and provides the service page, so as to allow the user to move and add particular content information registered as the object in the received service page of another user to the service page of the user, so that the object registered in the service page can be shared between the users.

As described above, according to the personal object sharing method of the present disclosure, it is possible to satisfy various demands of users and also create a new service in a web environment by registering content information according to user's designation as an object to configure a service page and providing a sharing service of the registered object to users who access the corresponding service page when various application services are used.

Meanwhile, a personal object sharing method according to an embodiment of the present disclosure may be implemented in a form of a program command executable through various computer means and recorded in a computer-readable medium. The computer-readable medium may include a program command, a data file, a data structure, or a combination thereof. The program command recorded in the medium is specially designed and configured for the present disclosure, but may be used after being made known to those skilled in computer software fields. Examples of the computer-readable recording medium include magnetic media such as a hard disk, a floppy disk, and a magnetic tape, and optical media such as a CD-ROM and a DVD, magneto-optical media such as a floptical disk, and hardware devices specially configured to store and execute a program command, such as a ROM, a RAM, and a flash memory. Examples of the program command include a high-level language code executable by a computer using an interpreter as well as a machine language made by a compiler. The hardware device may be implemented to operate as one or more software modules in order to execute the operation according to the present disclosure, and vice versa.

While the present disclosure has been described with reference to exemplary embodiments in detail, it will be understood by those skilled in the art that the present disclosure is not limited to the embodiments and various modifications and changes in form and details may be made therein without departing from the spirit and scope of the invention as defined by the appended claims.

1. An object management system comprising:
a service apparatus configured to acquire content information selected for each application service, transmit the acquired content information to make a request for registering the content information as an object, and load and execute the registered object; and
an object management apparatus configured to define a basic object structure for registering the object, set one or more expanded object structures based on the defined basic object structure according to a type of designated content information, select, when content information is received from the service apparatus, an expanded object structure corresponding to a type of the received content information among the one or more set expanded object structures, extract attribute data constituting the received content information, insert the extracted attribute data to a parameter designated to the selected expanded object structure, and performing the object registration.

2. An object management apparatus comprising:
a structure configuration unit configured to define a basic object structure for registering an object of content information selected for each application service and set one or more expanded object structures based on the defined basic object structure according to a type of designated content information;
an information receiver configured to acquire the content information selected for each application service; and
an object registering unit configured to select an expanded object structure corresponding to a type of the received content information among the set one or more expanded object structures, extract attribute data constituting the received content information, insert the extracted attribute data into a configuration parameter designated to the selected expanded object structure, and perform an object registration.

3. The object management apparatus of claim 2, wherein the structure configuration unit calculates a basic data structure for combining different data structures according to a type of designated content information, designates two or more configuration parameters corresponding to the calculated basic data structure, and defines the basic object structure by combining the designated two or more designated configuration parameters.

4. The object management apparatus of claim 3, wherein the structure configuration unit sets each of the expanded object structures corresponding to the type of the content information by changing and designating the two or more configuration parameters included in the basic object structure.

5. An object management method comprising:
defining a basic object structure for registering an object of content information selected for each application service by an object management apparatus;
setting one or more expanded object structures based on the defined basic object structure according to a type of designated content information by the object management apparatus;
transmitting the content information selected for each application service and making a request for registering the content information as an object by a service apparatus;
selecting an expanded object structure corresponding to a type of the content information selected from the service apparatus by the object management apparatus;
selecting an expanded object structure corresponding to the type of the received content information;
extracting attribute data constituting the received content information, inserting the extracted attribute data into a configuration parameter designated to the selected expanded object structure, and performing an object registration.

6. A method of operating an object management apparatus, the method comprising:
defining a basic object structure for registering an object of content information selected for each application service;
setting one or more expanded object structures based on the defined basic object structure according to a type of designated content information;
acquiring the content information selected for each application service;
selecting an expanded object structure corresponding to a type of the acquired content information among the set one or more expanded object structures;
extracting attribute data constituting the received content information, inserting the extracted attribute data into a configuration parameter designated to the selected expanded object structure, and performing an object registration.

7. An object sharing system comprising:
a service apparatus configured to provide one or more application services to accessed users, transmit service information according to a user's designation to make a request for registering the service information as an object in accordance with each of the application services, receive a search list of the registered object based on an object sharing request by a user according to provision of a particular application service, and load and execute registered objects corresponding to remaining application services except for the particular application service among the one or more application services based on the search list; and
an object management apparatus configured to register the service information received from the service apparatus as an object, provide a search list of registered objects according to an object sharing request by the service apparatus, and extract and provide the loaded object based on the search list.

8. A service apparatus comprising:
a service provider configured to provide one or more application services to accessed users;
an object registering unit configured to extract service information according to a user's designation in accordance with each of the application services and register the extracted service information as an object; and
an object executer configured to load and execute registered objects corresponding to remaining application services except for a particular application service among the one or more application services based on an object sharing request by a user according to provision of the particular application service.

9. The service apparatus of claim 8, wherein, when the object of the service information is registered, the object registering unit transmits and additionally registers type information for identifying a type of the transmitted service information, additionally registers service identification information for identifying an execution environment of the corresponding application service from which the service information is extracted, or additionally registers sharing setting information for designating counterparts with which each object is shared.

10. The service apparatus of claim 8, wherein, when the request by the user according to the provision of the particular application service is received, the object executer acquires a search list of the registered object and loads and executes one or more registered objects corresponding to the remaining application services except for the particular application service among the one or more application services based on the acquired search list.

11. An object management apparatus comprising:
a registration processor configured to receive service information designated to correspond to each of application services from a service apparatus providing one or more application services to accessed users and register the service information as an object; and
a load processor configured to execute and provide registered objects corresponding to remaining application services except for a particular application service among the one or more application services when an object sharing request according to provision of the particular application service is received from the service apparatus.

12. The object management apparatus of claim 11, wherein the registration processor additionally registers type information for distinguishing a type of the service information when the object of the service information received from the service apparatus is registered, and the load processor selects and provides an object requested to be shared based on type information of the registered object when the object sharing request according to the provision of the particular application service is received from the service apparatus.

13. The object management apparatus of claim 11, wherein the registration processor additionally registers service identification information for identifying an execution environment of the corresponding application service from which the service information is extracted when the object of the service information received from the service apparatus is registered, and the load processor selects and provides an object executable in the particular application service based on the service identification information of the registered object when the object sharing request according to the provision of the particular application service is received from the service apparatus.

14. The object management apparatus of claim 13, wherein, when the object sharing request according to the provision of the particular application service is received from the service apparatus, the load processor identifies an execution environment of the registered object based on the service identification information, and converts a format of the corresponding object to a format executable in the particular application service and provides the converted format of the object when the identified execution environment is different from an execution environment of the particular application service.

15. The object management apparatus of claim 11, wherein the registration processor receives sharing setting information corresponding to the service information received from the service apparatus and sets a counterpart with which each of the registered objects is shared when the object is registered, and the load processor identifies a counterpart transmitting the object sharing request, determines whether there is a counterpart with which the object is shared, and then provides the registered object when the object sharing request according to the provision of the particular application service is received from the service apparatus.

16. A method of operating a service apparatus, the method comprising:
providing one or more application services to accessed users;
extracting service information according to a user's designation in accordance with each of the application services and registering the extracted service information as an object; and
loading and executing registered objects corresponding to remaining application services except for a particular application service among the one or more application services based on an object sharing request by a user according to provision of the particular application service.

17. A method of operating an object management apparatus, the method comprising:
receiving service information designated to correspond to each of application services from a service apparatus providing one or more application services to accessed users;
registering the service information received from the service apparatus as an object for each user; and
extracting and providing registered objects corresponding to remaining application services except for a particular application service among the one or more application services based on an object sharing request by the service apparatus according to provision of the particular application service.

18. A service apparatus comprising:
a service access unit configured to access one or more application services;
an information acquiring unit configured to acquire content information selected for each application service;
an object registering unit configured to transmit the acquired content information and make a request for registering the content information as an object for each application service; and
an object executer configured to load and execute a particular registered object while accessing a particular application service.

19. The service apparatus of claim 18, wherein the information acquiring unit provides a first user interface in accordance with an access to a first application service, acquires content information selected from at least one of the first application service and a second application service through the first user interface in a state where a second user interface is provided in accordance with an access to the second application service, and acquires content information selected from at least one of the second application service and the first application service through the second user interface.

20. The service apparatus of claim 18, wherein, when the registered object is loaded, the object executer transmits pre-designated content format information, and acquires and executes the particular object of which a data format is converted based on the content format information.

21. An object management apparatus comprising:
an information receiver configured to receive acquired content information from a service apparatus acquiring the content information selected for each application service;
a registration processor configured to distinguish the content information received from the service apparatus as an object for each application service and register the distinguished object; and
a load processor configured to extract and provide the corresponding object according to a load of the registered object.

22. A method of operating a service apparatus, the method comprising:
accessing one or more application services;
acquiring content information selected for each application service;
transmitting the acquired content information and making a request for registering the content information as an object for each application service; and
loading and executing a particular registered object while accessing a particular application service.

23. A method of operating an object management apparatus, the method comprising:
receiving acquired content information from a service apparatus acquiring the content information selected for each application service;
distinguishing the content information received from the service apparatus as an object for each application service and registering the distinguished object; and
extracting and providing the corresponding object according to a load of the registered object.

24. A service apparatus comprising:
an information acquiring unit configured to acquire content information selected for each application service;
an object registering unit configured to transmit the acquired content information and make a request for registering the content information as an object; and
a service access unit configured to receive one or more sharing services of the registered object on a service page through an access to the service page.

25. The service apparatus of claim 24, wherein, when the object of the content information acquired from a particular application service is registered, the object registering unit additionally transmits sharing setting information of the content information to designate a counterpart with which the content information registered as the object is shared based on the sharing setting information, or designates a number of times the content information can be moved and added between users when the content information is shared.

26. The service apparatus of claim 24, wherein, when the content information acquired from a particular application service is registered as the object, the object registering unit additionally transmits content format information of the content information and allows a format of the content information registered on the service page to be converted based on the content format information.

27. An object management apparatus comprising:
a content information receiver configured to receive content information from a service apparatus acquiring the content information selected for each application service;
a page configuration unit configured to register the received content information as an object and configure a service page for each user; and
a service provider configured to provide a corresponding service page according to a request for the service page by a particular user and provides one or more sharing services for the registered object.

28. The object management apparatus of claim 27, wherein the page configuration unit additionally registers sharing setting information of particular content information and configures the service page when the object of the particular content information is registered, and the service provider limits counterparts with which the particular content information is shared based on the sharing setting information of the particular content information registered as the object on the service page or limits a number of times the particular content information can be moved and added between users when the particular content information is shared.

29. A method of operating a service apparatus, the method comprising:
acquiring content information selected for each application service;
transmitting the acquired content information and making a request for registering the content information as an object; and
receiving one or more sharing services for the registered object on a service page through an access to the service page.

30. A method of operating an object management apparatus, the method comprising:
receiving acquired content information from a service apparatus acquiring the content information selected for each application service;
registering the received content information as an object and configuring a service page for each user; and
providing a corresponding service page according to a request for the service page by a particular user and providing one or more sharing services for the registered object.
